(19) United States
(12) Patent Application Publication
(10) Pub. No.: US 2011/0176788 A1
(43) Pub. Date: Jul. 21, 2011

(54) Method and System for Associating an Object to a Moment in Time in a Digital Video

(76) Inventors: John Stuart Bliss, Boulder, CO (US); Matt Ludwig, South Portland, ME (US); Gregory Martin Keller, Boulder, CO (US)

(21) Appl. No.: 12/973,677

(22) Filed: Dec. 20, 2010

Related U.S. Application Data
(60) Provisional application No. 61/287,817, filed on Dec. 18, 2009.

(51) Int. Cl. H04N 5/91

(52) U.S. Cl. 386/241; 386/E05.003

(57) ABSTRACT

A system and method for object association with a digital video. The method includes determining a marked moment in a timeline of a source digital video by a computer. The marked moment is associated with an object, and more particularly, the marked moment is associated with a representation of the object. For instance, in one implementation, the marked moment is associated with a caption including textual commentary related to the marked moment and/or the digital video.

### CROSS REFERENCE TO RELATED APPLICATIONS

The present application claims priority to and the benefit of U.S. Provisional Patent Application No. 61/287,817, entitled “Method And System For Associating Text To Any Point in Time In A Video,” filed on Dec. 18, 2009, which is herein incorporated by reference in its entirety.

### BACKGROUND OF THE INVENTION

1. Field of the Invention

The present invention relates to the use of video in social media, and more specifically to the association of an object to a moment in time of a digital video.

2. The Relevant Technology

The emergence of social media ushers in an exciting frontier for internet users across the globe. Social media is able to bring together networked participants for purposes of interaction around a particular media platform. In particular, video is one particular form of digital media used more and more for purposes of social interaction. This may be driven by advances in technology allowing ordinary consumers, using every-day devices (e.g., mobile phones, personal digital assistants, smart phones, mobile computing devices, cameras, video-cameras, etc.), to capture and upload videos to easily accessible video hosting services and share it with their social networks.

However, the amount of data any user is required to consume daily in a social media-driven society is reaching staggering proportions. Time management of such data is becoming a major issue for internet users, and other participants accessing one or more social networks across one or more communication platforms. Of the many data streams a participant must synthesize daily, video is proving to be a major component in occupying that participant's time. As such, more and more time is being spent by the participant viewing one or more video “haystacks” that have no relation to other pieces of information in order to search for and find the elusive data “needle” that shows the importance of that video, at least for purposes of social interaction. As an example, little is known about the inner content of a video, and how and where other on-line social networking participants are engaging with that video.

It is desirous to explore ways to facilitate the use of video as a means to improve the efficiency of communication between socially networked participants, such as video.

### SUMMARY OF THE INVENTION

The present invention relates to systems and methods for object association within a digital video. In one embodiment, the method includes determining a marked moment in a timeline of a source digital video by a computer. The marked moment is associated with an object, or a representation of the object, or information relating to the object. For instance, in one implementation, the marked moment is associated with a caption including textual commentary related to the marked moment and/or the digital video. By enabling object association to exist within the context of a source digital video, embodiments of the present invention allow viewers of a source digital video, including object associations with moments in time, to be afforded additional information, data, or content (e.g., viewable content) that is related to specific scenes in the video. In addition, by marking the source digital video, a data platform is provided that stimulates interaction between various participants over particular moments in time and their respective object associations of a particular video. Furthermore, this additional user-generated data associated with marked moments enables better discovery of video assets by search indices which otherwise would not be able to index and utilize the video asset in an internet user's relevant content search.

In another embodiment, a video marking system is disclosed that is configurable for making an object association with a moment in a digital video. The system includes a video controller for determining a video identifier that identifies a source digital video. In particular, the video identifier facilitates access to the source digital video. A timestamp monitor is included within the system for determining a marked time in a timeline of the source digital video. For instance, the marked time is associated with a marked moment in the source digital video. In addition, a marking module associates a representation of an object with the marked moment.

Moreover, in another embodiment, digital information is disclosed comprising a moment in a digital video. The moment corresponds to a particular scene, or scenes, or frame, or frames, in the digital video. In addition, the digital information includes a representation of an object that is associated with the moment. As such, the object association with the moment enables indexing of video archives, and in particular, indexing of particular moments in a digital video. By providing for object association, other information, data, or content that have some relation to the object association can also be indexed and accessed through the object association.

In still another embodiment, a marking of digital information is disclosed that facilitates object associations with scenes in a digital video. In particular, the marking includes a video identifier that identifies a source digital video. For instance, the video identifier facilitates access to the source digital video. In addition, the marking includes a marked time in a timeline of the source digital video. The marked time is associated with a marked moment in the source digital video, where a user marks the marked moment for purposes of making an object association. The marking includes a representation of an object, such that the representation of the object and/or the object is associated with the marked moment.

In another embodiment, a method for marking video is disclosed. The method includes determining a marked moment of a source digital video by a computer.

Location information is also determined by the computer. The location information is associated with the marked moment by the computer.

In still another embodiment, a method for distributing a marked video is disclosed. The method includes receiving a request for a marked video snip from a viewer's computer. The source digital video associated with the marked video snip is determined. The source digital video is requested and received from a host video server. A marked time associated with a marked moment in the source digital video is determined, wherein the marked moment is associated with an object, such as location information. The source digital video is sent to the viewer's computer, wherein the source digital video is aligned to play at the marked moment.

A video snipping system is disclosed configured to create and distribute a marked video, in accordance with one embodiment of the present invention. The system includes a video controller for determining a globally unique video identifier identifying a source digital video. A timestamp monitor is included within the system for determining a marked time in a timeline of the source digital video, wherein the marked time is associated with a marked moment in the source digital video. A marking module is included for associating location information with the marked moment.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of a system for associating an object in a digital video, in accordance with one embodiment of the present invention.

FIG. 2 is a block diagram of a video snipping system capable of associating an object to a moment in time in a digital video, in accordance with one embodiment of the present invention.

FIG. 3A is an illustration of related information making an object association with a particular moment in time of a digital video, in accordance with one embodiment of the present invention.

FIG. 3B is an illustration of related information making an association between an object and a video snip, in accordance with one embodiment of the present invention.

FIG. 4 is a flow diagram illustrating a method for associating an object with a particular moment in time in a digital video, in accordance with one embodiment of the present invention.

FIGS. 5A and 5B combined is a data flow diagram illustrating the flow of information when implementing a method and/or system for making an object association with a particular moment in time of a digital video, in accordance with one embodiment of the present invention.

FIG. 6 is an exemplary data flow diagram 600 illustrating the flow of information when implementing a method and/or system for requesting delivery of a marked video that includes information relating to an object association with a particular moment in time, in accordance with one embodiment of the present invention.

FIG. 7 illustrates the relationship amongst a creator user, a mentioned friend, a video snip, and a source video that is marked with textual commentary and/or a friend mention, in accordance with one embodiment of the present invention.

FIG. 8 is a block diagram illustrating the relationship between a video and associated video snips, in accordance with one embodiment of the present invention.

FIG. 9 is a flow diagram illustrating the steps in a method that may be executed to monitor responses and submit comments in accordance with an illustrative embodiment of the present invention.

FIG. 10 is a flow diagram illustrating the steps in a method that may be executed to create a mention associated with a video snip in accordance with an illustrative embodiment of the present invention.

FIG. 11A is a screen shot of a website page streaming a digital video and a user interface used to control play and mark moments in time of the digital video, in accordance with one embodiment of the present invention.

FIG. 11B is a screen shot of a website page streaming a marked digital video and a user interface used to control play of the digital video, to interact with marked moments in time, and to mark additional moments in time of the marked digital video, in accordance with one embodiment of the present invention.

FIG. 12 is a flow diagram illustrating a method for marking video with location information, in accordance with one embodiment of the present invention.

FIG. 13 is an illustration of a source digital video marked with one or more marked moments, where the source video stitches together separately taken videos, in accordance with one embodiment of the present invention.

FIG. 14 is a flow diagram illustrating a method for distributing video marked with location information, in accordance with one embodiment of the present invention.

### DETAILED DESCRIPTION OF THE PREFERRED EMBODIMENTS

Reference will now be made in detail to the preferred embodiments of the present invention, to include a system and method for the association of an object to a particular moment in time of a digital video. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention as defined by the appended claims.

Accordingly, embodiments of the present invention provide for the ability to mark, share with others, and create a community around a specific scene, or moment in time, in a digital video for purposes of discussion. Still other embodiments provide the above advantage, and further provide for rapid engagement, syndication and distribution, and communal discussion of a particular moment in time of a digital video, and also spark discussion around a video snip that begins with that particular moment in time. Also, other embodiments provide the above advantages, and further provide for deeper engagement by participants with web publishers and web bloggers through the use of digital videos that are marked at particular moments with corresponding object associations. Further, other embodiments provide the above advantages, and also provide for the distribution of video content by socially-motivated internet users to their large social networks through the use of marking that video content with object associations.

### NOTATION AND NOMENCLATURE

Embodiments of the present invention can be implemented on software running on a computer system. Other embodiments of the present invention can be implemented on specialized or dedicated hardware running on a computer system, or a combination of software and hardware running on a computer system. The computer system can be a personal computer, notebook computer, server computer, mainframe, networked computer, handheld computer, personal digital assistant, workstation, and the like. This software program or its corresponding hardware implementation is operable for marking a digital video, such that at a particular moment in time of a video is marked, and an object is associated with that marked moment. In one embodiment, the computer system includes a processor coupled to a bus and memory storage coupled to the bus. The memory storage can be volatile or non-volatile and can include removable storage media. The computer can also include a display, provision for data input and output, etc.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “associating,” “determining,” “accessing,” “receiving,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

Further, throughout the application, the term “database” may be used to describe a location for storing information or data, and/or a mechanism for storing information or data. As such, “database” is interchangeable with the following terms: storage, data store, etc.

In addition, throughout the application, embodiments of the present invention describe the use of video to facilitate social networking, where the terms “video,” “video sequence,” “digital video sequence,” or the like are intended to represent the electronic capture of a sequence of images or scenes that when played shows motion of whatever is captured within the images.

Further, throughout this application the term “mark,” “marking,” or any of its derivatives may be used to establish an association between two or more items of information. The term may function to mark, label, categorize, tag a video with one or more objects, data, and/or related information.

Object Association with a Moment in Time in a Digital Video

Embodiments of the present invention facilitate the association of an object with a particular moment or point in time in a digital video being displayed through a user's computer, such as with the assistance of a web browser, a locally managed video renderer, or any other suitable device assisting in retrieving and displaying information from other devices over a communication network. As a result, that moment in time is associated with an object that provides access to additional content, all of which have some association with the object, a representation of the object, or the moment in time associated with the object. For instance, the object or a representation of the object is searchable such that other content having similar object associations are discoverable, thereby linking all content with similar object associations.

By enabling content (information related to object associations) to exist within the context of a digital video, the present invention allows users viewing a digital video to be afforded additional viewable content associated with specific scenes in the digital video, and to interact with other users offering additional content. In so doing, the present invention enhances the value of a digital video provided by a hosting service, for example, by enabling human-indexing of archives. Should users desire, the present invention could facilitate the creation of an aggregated collection of video content filtered by subject/interest area, in one embodiment.

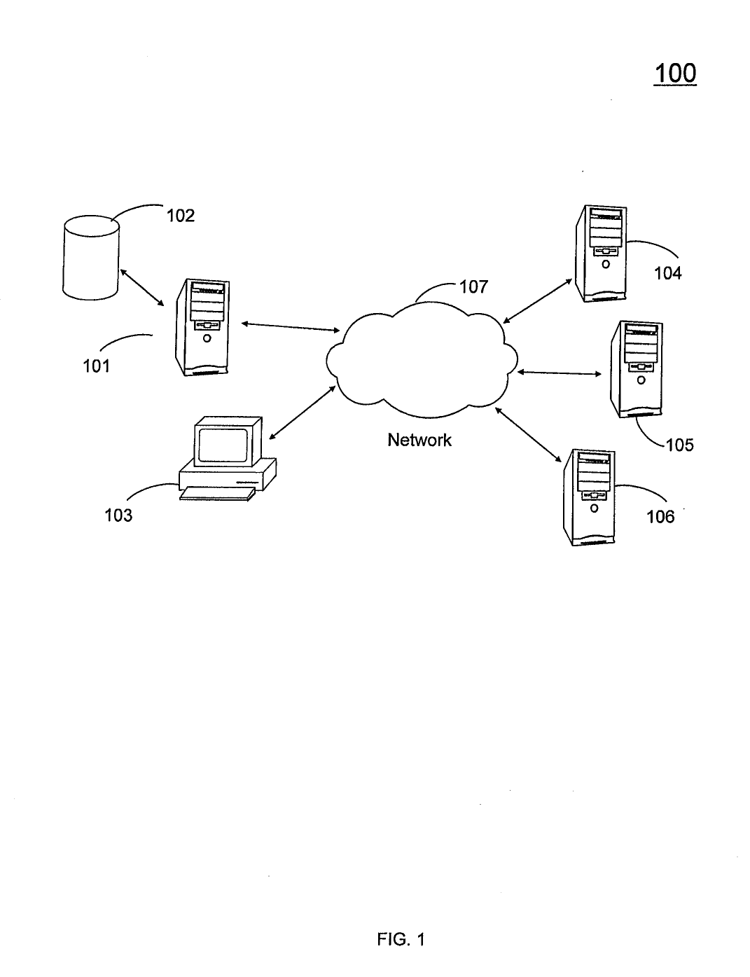

FIG. 1 illustrates an exemplary system 100 that is capable of making object associations with corresponding moments in time of a digital video, in accordance with one embodiment of the present invention. System 100 is configurable to enable a creator user to mark a video with object associations at particular moments in time, and share the marked video along with the object associations throughout the user's social network, and further make the marked video searchable through the object associations such that it is available to others having interest in those objects and/or object associations.

System 100 includes a video snipping system 101, a data store 102, a user computer 103, a plurality of server computers 104, 105, 106, and a communication network 107. In particular, the marking computer 101 may generate and/or populate the data store 102 based on data retrieved through the network 107, as described in further detail herein. Although the data store 102 is illustrated external to the video snipping system 101, it is contemplated that the data store 102 may be an integral component of the video snipping system 101, such that, information, data, and/or content may be stored in memory of the video snipping system 101, and/or may be resident in a separate memory, or an electronic storage medium.

The video snipping system 101 may communicate with the user computer 103 and/or one or more of the server computers 104, 105, and 106 through the communication network 107. The communication network 107 facilitates communication between various devices. As examples, the communication network 107 includes, but is not limited to, a telecommunications network, a mobile phone network, a local area network (LAN), a wide area network (WAN), a wireless LAN (WLAN), a metropolitan area network (MAN), a personal area network (PAN), the internet, and/or combinations thereof.

The server computers 104, 105, and 106 may each host one or more websites, which may be accessed over the communication network 107. In addition, video snipping system 101 and the user computer 103 may also host one or more websites accessible over the communication network 107. For example, a user through a user computer 103 accesses a website that is hosted on one of the server computers 104, 105, and 106. The user's computer is configured to retrieve, traverse, and present information resources (e.g., web pages and their associated content) over a network, such as the internet. For instance, a browser or any suitable device may be used to access the information. More particularly, the computer is configured to display pages of the website on a display of the user computer 103. For instance, many websites offer video hosting services to users via the communication network 107, such as the internet. Consequently, a user may access a website through the user's computer to review videos or post videos to the website.

Furthermore, the user through the user computer 103 may access the video snipping system 101 to mark video content, where the video content is provided through third party server computers 104, 105, 106, the marking computer 101, or the user computer 103. In that manner, the user is able to access or provide the video content, mark particular moments in time in the video content, and associate objects with those moments in time, through the use of the video snipping system 101. In general, the video snipping system 101 executes processes for marking video content from any number of websites and/or sources, and generates and/or populates the data store 102 with information based on such marking activity. In particular, the information includes object associations with particular moments in time of a digital video, such that any user is able to access related information and content based on those object associations.

In some implementations, the video snipping system 101 may function as a proxy server, which acts as an intermediary for requests from clients, e.g., the computer 103, seeking resources from other servers, e.g., the computer 103, and/or one or more of the servers 104, 105, 106.

In an illustrative example of embodiments of the present invention, a creator user is viewing a video on a third party video hosting website (e.g., YouTube®, Facebook®, Twitter®, etc.) and would like to share a portion of the video with other viewers. Instead of sending a link to the video via the third party video hosting website, the creator user directs other viewers to a specific portion of the video, or a snip of the video via the video snipping system 101. Furthermore, this is accomplished without also utilizing video editing technology to edit or delete the unwanted portion of the video, in one embodiment.

The creator user determines both the starting and ending time to be associated with the video snip. The creator user also makes an object association with a corresponding moment in time, that also acts as the starting time of a corresponding video snip. For instance, the creator user may mark a particular moment in time with a caption or comment as an object. A viewer is able to respond to the caption/comment, or to other responses from other viewers to the caption/comment, in embodiments. In another embodiment, the creator user may mark a particular moment in time with an association with a representation of a “friend” from one of the creator user's social networks (e.g., Facebook®, MySpace®, YouTube®, Twitter®, etc.). That is, a “friend” is “mentioned” within the context of a particular moment in time of the source digital video.

Throughout this application, the term “mention” is used to represent the identification of an individual or entity. The individual or entity, as a friend, is part of one or more social network of friends associated with a particular user, such as the creator user who is marking a source digital video. In one implementation, the term “mention” is analogous to a tagging feature, in which the individual or entity is tagged or identified within a scene corresponding to a moment in time of a video. In that manner, the mention of the friend is associated with the moment in time, as an object. In another implementation, the term “mention” may refer to a term of art used to represent a representation of an individual or entity. For instance, the social messaging service provided by Twitter® identifies its participants by mentions, such as “@individual-name; or @entity-name, etc.).

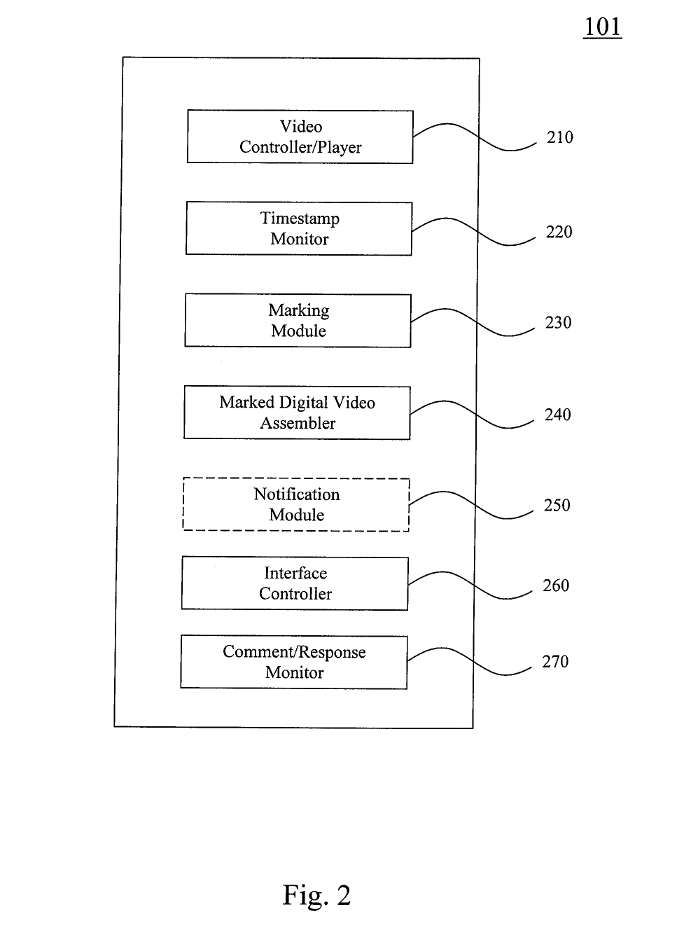

FIG. 2 is a block diagram of a video snipping system 101 capable of associating an object to a moment in time in a digital video, in accordance with one embodiment of the present invention. In one implementation, system 101 is included within the overall system 100 of FIG. 1, and provides for a creator user to make object associations with particular moments in time of a digital video. The marked digital video is then capable of being shared throughout the creator user's social networks. In addition, the marked digital video is searchable through the object associations, so that others interested in marked moments, the object, or object associations are able to access the marked digital video.

The video snipping system 101 includes a video controller/player 210 that determines a video identifier that identifies a source digital video. In one implementation, the video identifier is unique within the video snipping system 101, such that the source digital video is distinguishable from any other source digital video no matter where those other videos are hosted, stored, or accessed.

In one embodiment, the video identifier includes a source video uniform resource identifier (URI), which provides access to the source digital video that is hosted on a web site, such as a video hosting service, a blogging page, a social networking page of a user, etc. In another implementation, the video identifier is mapped to the source video URI. In general, a URI provides access to files that are hosted on a web site and retrieved for display within a user's computer requesting those files. In one example, a uniform resource locator (URL) is one form of the URI that is used for accessing pages of a web site. As an example, the video controller 210 receives the source video URI from the creator user's computer, wherein the source video URI points to a video server hosting the source digital video.

In still another embodiment, the video identifier includes a user identifier provided to the user by the video snipping service. For instance, the source video URI and the user identifier are concatenated to define a unique video identifier.

As such, the video controller/player 210 is able to access the source digital video from a host video server (e.g., third party host video server, internal video server, from a user, etc.). Also, the video controller/player 210 is able to deliver the source digital video to a user for viewing and marking purposes. More specifically, the video controller/player 210 is able to control play of the source digital video as delivered to the user's computer 103. That is, the video snipping system 101 acts as the intermediary source of the digital video for marking purposes.

The video snipping system 101 also includes a timestamp monitor 220 that is capable of determining a marked time in a timeline of the source digital video. Specifically, the marked time is associated with a marked moment in the source digital video. For instance, the timestamp monitor 220 is capable of determining when a creator user marks a particular moment in time of a video, and is able to determine the point in time in a timeline associated with the marked moment. As such, the marked moment corresponds to a marked time in the timeline of the source digital video.

In one embodiment, the timestamp monitor 220 is able to determine the marked time by requesting that information from a third party video host server that is hosting the source digital video, and through which the video is being played. For instance, in one implementation, the timestamp monitor 220 is able to access information through interactions with the video host server's application programming interface (API). As such, timestamp monitor 220 is able to request the marked time from a video player, for example, provided by the video host server. That marked time is consistent no matter what party is requesting the source digital video, since the video player provided by the video host server is consistent between all requesting parties. Further, the video snipping system 101 is able to access the API to control the delivery of the source digital video, as will be further described below.

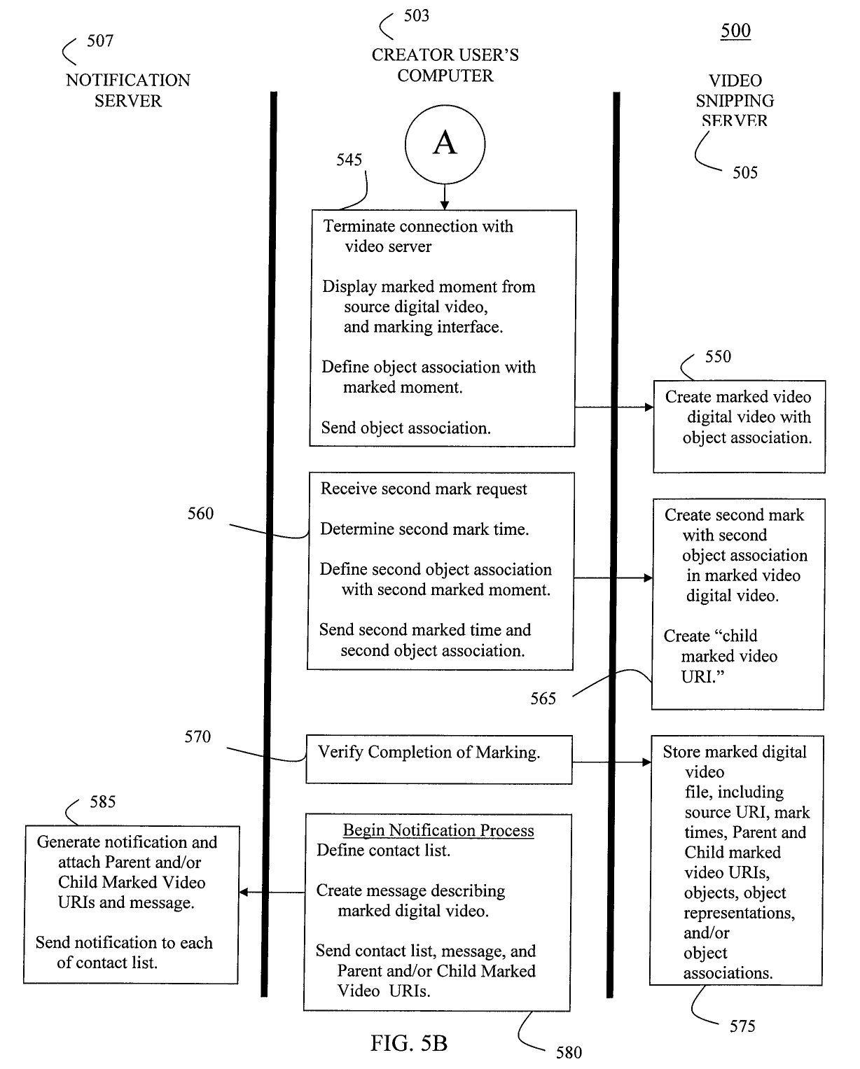

In another embodiment, the timestamp monitor 220 is able to determine the marked time by monitoring the play of the source digital video. For instance, the timestamp monitor 220 is able to monitor the playing of the video on the creator user's computer. In another implementation, the timestamp monitor 220 is able to monitor the playing of the source digital video as it is being routed through the video snipping system 101, as will be further described below in relation to FIGS. 5A and 5B.

Video snipping system 101 also includes a marking module 230 for associating a representation of an object and/or the object with the marked moment. In one implementation, the marking module 230 receives information, from the computer of the creator user, identifying the object, or a representation of the object, in association with the marked moment. As such, the video snipping system 101 is able to make an association between the marked moment and the object, or a representation of the object.

In that manner, the video snipping system 101 is able to provide access to a marked digital video, based on information related to the video identifier, a marked moment, and an object association of the marked moment. More particularly, the marked digital video assembler 240 is able to identify a marked digital video based on the information described above to a viewer requesting a particular moment or a snipped video.

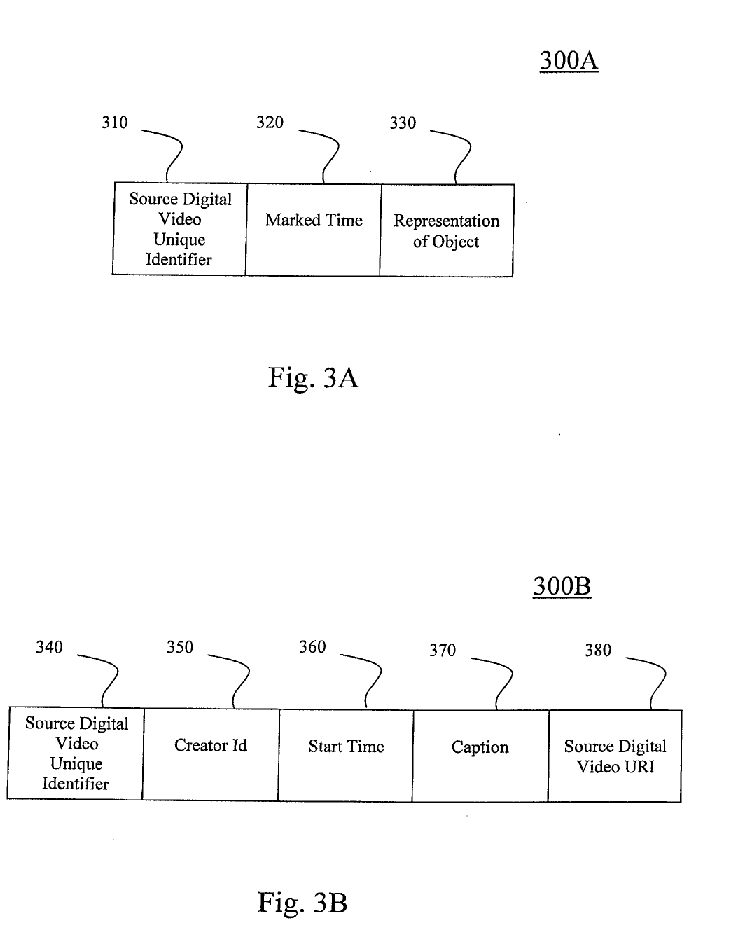

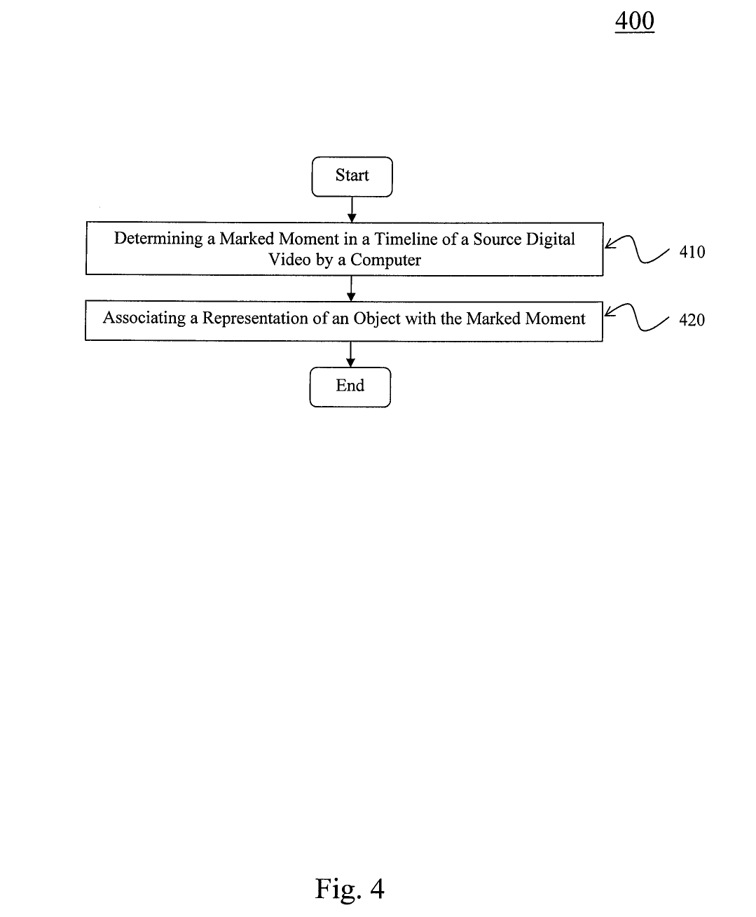

For instance, FIG. 3A illustrates the structure of a video snip field (VSF) 300A that facilitates access to a marked digital video by the marked digital video assembler 240, in accordance with one embodiment of the present invention. The VSF 300A includes components of a video snip, and more specifically provides access to a marked digital video, or video snip, as generated by the video snipping system 101.

The VSF 300A is comprised of a source digital video unique identifier 310, a marked time 320, and a representation of an object 330. The unique identifier 310 is assigned to a particular video, such that it is identifiable within the video snipping system 101. In one embodiment, the unique identifier comprises a URI used to access or locate the source digital video by the video snipping system 101.

In addition, the VSF 300A includes the marked time 320. As previously described, the marked time is associated with a marked moment in a timeline of the source digital video. In one embodiment, the marked time is provided by the player associated with the video hosting service for consistency during the creation of marked moments, and during the access of those marked moments by viewers of the marked digital video.

Also, the VSF 300A includes a representation of the object 330. The representation of the object 330 provides access to the object, or provides additional information relating to the object. In some embodiments, VSF 300A includes the object itself. The object and/or object association promotes social networking or interaction around a particular moment in time of a digital video. For instance, the object may be a caption that describes or makes a comment on the marked moment. As such, the marked moment may form the platform through which the marked moment is shared, and over which social interaction occurs between members of a social network, such as promoting a discussion around the marked moment. Representative examples of objects are provided, but are not limited to, the following: caption, commentary, socially networked friends, individuals, entities, time, date, places, geo-locations, images, other videos, etc.

In addition, the object or the representation of the object is able to provide a reference point that indexes, associates, connects, or links other information to that particular moment in time. For instance, an object that comprises a geo-location (e.g., global latitude and longitude information) associated with where the marked moment is located may connect a marked moment and its corresponding marked digital video to other information, such as other videos taken at or near the same geo-location, or information about geographic features, entities, activities, stores, etc. found at or near the geographic location.

As shown in FIG. 3A, a marked digital video is identifiable by the information contained within VSF 300A. More specifically, the marked digital video assembler 240 is able to provide access to or generate a marked digital video based on information included in VSF 300A. For instance, the video identifier allows the video assembler 240 to access the source digital video from which the marked digital video, including information related to such, is created for a viewer.

The marked time allows the video assembler 240 to align the source digital video to the marked moment, such that when delivered to a viewer's computer the marked digital video is either paused at the marked moment, or begins playing at the marked moment by the video player. As such, the video assembler 240 is able to assemble and deliver a snip of the source digital video that corresponds to the marked digital video. The video snip comprises a subset of the source digital video beginning at a start time corresponding to the marked time, and ending at some user defined moment in the video, or at the end of the source digital video. In addition, the object or the representation of the object is also displayable along with the marked moment.

In still another embodiment, a marked digital video comprises a moment in a digital video, and a representation of an object associated with the moment. The moment defines a specific frame or image within a sequence of images that forms the digital video. That moment is distinguishable and unique from other moments in the same and other digital videos. As such, in embodiments of the present invention, a moment is also associated with a representation of an object, or with the object itself. In that manner, that moment is sharable with others to promote social interaction around that moment, or is discoverable by others based on the object, representation of the object, and/or the object associations with the moment.

In one embodiment, the information relating to the marked digital video, such as information included in VSF 300A, is located in a file location defined by a marked video URI associated with the video snipping system 101. For instance, the file may be located in data store 102 of FIG. 1. As such, by requesting the marked video URI, the marked digital video is accessed. The marked digital video may be associated with one or more marked video URIs. For instance, a parent marked video URI points to information associated with a first marked moment of a source digital video. In addition, a child marked video URI points to information associated with a second marked moment of a source digital video. A viewer requesting to view marked moments may provide either the parent or child marked video URI. By requesting the parent marked video URI, the viewer is delivered the source digital video that is aligned to pause or begin play at the first marked moment. A request for the child marked video URI will deliver the source digital video to the viewer that is aligned to pause or being play at a second marked moment.

Turning back to FIG. 2, the video snipping system 101 includes a notification module 250 that is capable of sharing the marked digital video with various parties. For instance, the notification module 250 is able to determine a list of contacts of interest to a user who has created a marked digital video, such as a video snip based on a marked moment. The module 250 sends a notification to each of the contacts in the list. As shown in FIG. 2, the notification module 250 may be optionally included in video snipping system 101. Also, the services provided by the notification module 250 may be provided by a third party.

In particular, the notification module 250 is capable of generating a notification of the marked digital video. The notification includes at least one marked video URI, such as a parent and/or child marked video URI, that correspond to marked moments in the source digital video. As such, by requesting a specific marked moment URI (e.g., clicking on the link provided through the URI), a viewer is delivered a source digital video aligned to a corresponding marked moment.

Also, the notification includes a message from the creator user through whatever communication means is available. In one implementation, the message is received from a user's computer 103, and is attached to the notification. In another implementation, the message is received through a messaging service provided by a social network service provided in a client-based social media dashboard. As an example, the message is related to the marked moment, and/or the video snip associated with the marked moment. For instance, the message may be a message that provides an invitation to view a marked digital video, such as “Check out this video!”.

The video snipping system 101 also includes an interface controller 260 for sending a marking interface to a user's computer. The interface controller 260 works in conjunction with the video controller/player 210 to deliver the marking interface along with the source digital video for viewing and marking purposes. In one implementation, the interface controller 260 sends the marking interface to the creator user's computer for viewing and marking purposes. In another implementation, the interface controller 260 delivers the marking interface to the viewer user's computer for viewing and marking purposes.

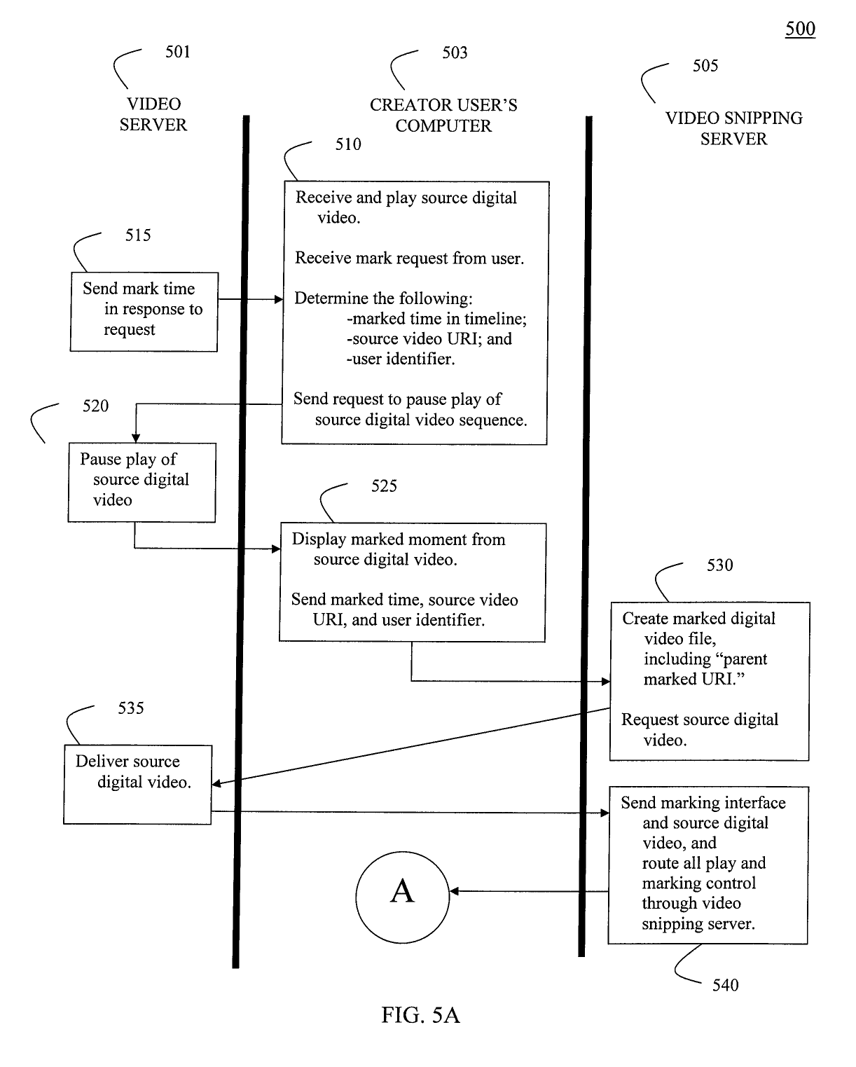

FIG. 4 is a flow diagram 400 illustrating a method for associating an object with a particular moment in time in a digital video, in accordance with one embodiment of the present invention. The method of FIG. 4 is implemented within the system 100 of FIG. 1, and more particularly, within the video snipping system 101 of FIGS. 1 and 2.

A marked moment in a timeline of a source digital video is determined 410. For instance, the marked moment is determined by the timestamp monitor 220 of the video snipping system 101 of FIG. 2. The marked moment corresponds to a specific moment in time within the video. For instance, the moment in time is one of a plurality of sequential moments, as represented by sequential images or frames that define the source digital video. In some embodiments, the marked moment corresponds to a series of moments, tightly connected over a short period of time. For instance, the marked moment may correspond to a one-half second, or a full second, of sequential images or frames within the source digital video.

In addition, a representation of an object, or more specifically, an object, is associated with the marked moment 420. The object association allows the creator user to link/associate members of a defined social network, or other users interested in the object association, to those user-defined key moments. These object associations add associated user-generated meta-data to the marked moments, thereby making it possible to index and further identify those marked moments.

As such, by defining key moments in a source digital video, and making object associations with each of those key moments, a creator user is able to mark a video, and share that marked video with other members of his or her social networks. In addition, by marking the source digital video with the object associations, the marked digital video is searchable by other interested parties.

FIGS. 5A and 5B combined provide a exemplary data flow diagram 500 illustrating the flow of information when implementing a method and/or system for making an object association with a particular moment in time of a digital video, in accordance with one embodiment of the present invention. For instance, in one embodiment, the data flow diagram 500 illustrates the flow of information as implemented by system 100 of FIG. 1, and the flow diagram 400 of FIG. 4. However, it is contemplated that in still other embodiments of the present invention, system 100 of FIG. 1 and flow diagram 400 of FIG. 4 are able to implement other variations of data flow for purposes of making object associations with particular moments in time.

Information flows between three separate parties within data flow diagram 500, where the parties include the video server 501, the creator user's computer 503, and the video snipping server 505. As shown, the video server 501 acts as the source of the source digital video. In some cases, the video server is a third party video hosting service. In other cases, the video server is internal to the video snipping system, such as system 101. In still other cases, the video server may be internal to the creator user's computer 503. Flow diagram 500 is modifiable depending on the location of video server 501. Additionally, the creator user's computer 503 is used by the creator user to define marked moments in a timeline of a video and make object associations with those marked moments. The video snipping server 505 facilitates the marking process, and provides access to the finished product, the marked digital video.

As shown in FIG. 5A, block 510 illustrates the handling of information within the creator user's computer. For instance, the creator user's computer 503, in one instance the browser of the of the computer 503, is able to receive a source digital video that is hosted on the video server 501. The video is played by a video player also provided and controlled by the video host server 501. As examples, the user may be simply viewing videos from a host service, or interacting with videos through a blog interface. At this point, no marking is contemplated by the creator user, and the video snipping service has not been activated.

At some point while viewing the source digital video that is hosted by the video server 501, the creator user is interested in marking a particular moment, and is able to make that intent known to the user's computer. For instance, the user may activate an icon on the computer that activates a process for marking. In one instance, a bookmarklet or other similar application that provides access to video snipping services, as activated by the icon, is available on the computer 503 for marking purposes. At any point when viewing a video, when the user first activates the bookmarklet, the marking process begins.

At this point, the user is intending to define a first marked moment in the source digital video. As such, a marked time associated with the marked moment is determined. In one implementation, the creator user's computer is able to access the APIs of the video server 501 to request the marked time on a timeline of the video player provided by the video server 501. For instance, the video server 501 is able to receive a request from the bookmarklet application for information via the API, and send back a marked time in response to the request, as shown in block 515. In other implementations, features of the creator user's computer are able to monitor the timeline of the video player to determine the marked time. That is, the timeline of any video playing on the creator user's computer is continually monitored.

In addition, the source video URI is determined. The information is readily available via the creator user's computer 503, since the computer has already accessed the source digital video using the source video URI. In this manner, the video snipping server 505 is able to access the source digital video for marking, distribution, and viewing purposes.

Also, a user identifier is determined. The user is associated with an account provided by the video snipping service. Through this account, the user is able to mark videos to create video snips, and access previously created video snips. Typically, the user identifier is unique within the video snipping service.

At this point, the user is beginning the marking process associated with the marked moment. As such, at the creator user's computer 503, the source digital video provided by the video server 501 is paused for display at the marked moment. For instance, as soon as the user marks that moment by activating the icon providing access to video snipping services, the source digital video is paused. In one implementation, a control instruction generated by the bookmarklet application is delivered from the user's computer 503 through the API of the video server 501 to pause the source digital video. As such, the video server 501 pauses the source digital video at that marked moment, as displayed on the creator user's computer 503, as shown in blocks 520 and 525.

In addition, information related to the marked moment is delivered to the video snipping server 505, as shown in block 525. For instance, the marked time, source video URI or some other video identifier, and the user identifier are delivered to the video snipping server 505 in block 525. More specifically, the video snipping server 505 receives the information from the user's computer 503, such as through the browser of the user's computer 503, in one implementation.

In block 530, the video snipping server 505 is able to begin creating a marked digital video file that is used to generate a marked digital video, for purposes of additional marking, distribution, and viewing. At the first marking, the file can be defined and accessed by a parent marked URI that is generated by and accessed through the video snipping server 505. The parent URI provides information that is used to generate a video snip of the source digital video beginning at the first marked moment, and ending at some pre-defined or user-defined moment in the timeline.

In addition, the video snipping server 505 requests the source digital video using the source video URI, previously determined. In block 535, the video server 501 delivers the source digital video to the video snipping server 505. In this manner, the video snipping server 505 is able to provide the source digital video for purposes of completing the marking process, and to facilitate any further marking by the creator user.

As such, in block 540, the video snipping server 505 sends a video player/marking interface along with the source digital video to the creator user's computer 503, as shown in connecting point A of both FIGS. 5A and 5B. More specifically, in block 545 of FIG. 5B, the user's computer 503 receives the video player/marking interface and source digital video for simultaneous display. The source digital video is paused and aligned to the marked moment for display. At this point, the video snipping server 505 takes control of the delivery of the video to the creator user's computer 503. That is, all play and marking control is routed through the video snipping server 505. For instance, the previous connection between the creator user's computer 503 and the video server 501 is terminated.

To the user, the exchange is conducted as seamlessly as possible. At one moment, the user is viewing the source digital video as delivered by the video server and paused at the marked moment. At the next moment, during the exchange of control, the user is viewing the same source digital video now delivered through the video snipping server 505 as an intermediary source along with the video player/marking interface. That is, the user is effectively ported over to the video snipping server 505 for purposes of interaction. With the introduction of the video player/marking interface, additional information can be collected with regards to the first marked moment from the user.

At this point, the user is able to define an object or a representation of the object that is associated with the marked moment through the video player/marking interface. Specifically, the user is able to further define the marked moment through object association. As previously described, the object may include, but is not limited to, a caption, textual commentary, a “friend” that is an individual or entity, a place, a geo-location, a time, etc.

Information related to the object association is delivered from the creator user's computer 503 to the video snipping server 505. That information may include the object, a representation of the object, or other information related to the object. As shown in block 550, the video snipping server is able to create the marked video digital video. More specifically, the video snipping server is able to store information necessary for building the marked video digital video, such as the URI for the source digital video, the marked time of the marked moment, and information related to the object association. Armed with that information, the video snipping server 505 is able to deliver a video snip to a requesting computer, where the source digital video is aligned to pause play, or begin play at the marked moment. In some embodiments, information related to the object association is also displayed with the marked moment.

The creator user is able to define other marked moments in the source digital video, and to make object associations with those marked moments. For instance, in block 560, the creator user's computer receives a second marking request. In one implementation, the creator user interfaces with the video player/marking interface provided by the video snipping server 505 to play the source digital video, and to further define a second marked moment that corresponds to a second marked time in the timeline. This may be accomplished through a button in the interface that is activated while the second marked moment is displayed on the user's computer 503. Upon activation, the source digital video is paused on the display of the user's computer 503 for purposes of marking.

At that point, the second marked time is determined. Again, this may be accomplished by a request made through the video server's 501 API, or may be determined by the video snipping server that is monitoring the timeline of the source digital video while it is played. The determination of the second marked time may occur within the creator user's computer 503, or the video snipping server 505, or a combination of the two.

In addition, information related to the second marked moment is delivered from the creator user's computer 503 to the video snipping server 505. For instance, the second marked time and the second object association (e.g., second object, a representation of the second object, or other information related to the second object) is delivered to the video snipping server 505. The video player/marking interface facilitates object association by providing an interface to define the object or a representation of the object corresponding to the second marked moment. As shown in block 565, the video snipping server 505 is able to create the second marked video digital video. More specifically, the video snipping server 505 is able to store information necessary for building the second marked video digital video, or second video snip, such as the URI for the source digital video, the second marked time of the second marked moment, and information related to the corresponding object association. Armed with that information, the video snipping server 505 is able to deliver a second video snip to a requesting computer, where the source digital video is aligned to pause play, or begin play at the second marked moment. In some embodiments, information related to the corresponding object association is also displayed with the second marked moment.

In one embodiment, a child marked video URI is generated that provides information used to generate the second video snip of the source digital video. For instance, the child marked video URI provides access to the point in the overall marked video file pertaining to the second marked moment, such as the second marked time, and information related to the second object association. As such, using the child URI, the video snipping server is able to generate the second video snip of the source digital video beginning at the second marked moment, and ending at some pre-defined or user-defined moment in the timeline.

At block 570, verification of the completion of the marking process is accomplished at the creator user's computer 503. As such, in block 575, the video snipping server is able to finalize the creation of the marked digital video. Specifically, information used to generate the marked digital video is stored in a file located in data store 102. As previously described, that information may include, but is not limited to, the source video URI, the parent and child marked URIs, object, object representations, and/or other information relating to the object associations.

The user may choose to distribute the marked video to his or her “friends” as defined by one or more social networks within which the user participates. For instance, the marking interface provides for distribution of the marked video through a notification service provided by a notification server 507. Although shown as a third party service, the notification server 507 may be conducted internally within the video snipping server 505.

As shown in block 580, the contact list for distribution is defined. For instance, the user may define the contact list using the marking interface. In one embodiment, the contact list comprises all of the friends of the user in a particular social network. In another embodiment, the contact list comprises selected friends of the user in a particular social network. In still another embodiment, the contact list comprises a user defined friend of the user.

In addition, the user is able to generate a message that is attached to the notification. The generation of the message is facilitated through the marking interface. For instance, the message may generally ask the recipient of the notification to “Check out this video snip!” The message is configurable to convey any type of message and may contain more specific information relating to the video snip, such as “Check out this video snip showing John Bliss bike riding at Nationals!”

Relevant information pertaining to the notification is passed to the notification server 507. As such, in block 585, a notification is generated that includes the attached message, previously generated. In addition, the notification includes the parent marked video URI and/or one or more child marked video URIs. In that manner, the recipient is able to select between a plurality of video snips based on the source digital video for viewing. Thereafter, the notification and attached message is delivered to each of the contacts in the contact list. The delivery of the notification may be accomplished via each of the recipient's associated social network platform. For instance, if a recipient is a friend of the creator user through a first social network, the notification is delivered via the messaging service provided by the first social network.

In addition, the video snip that is created based on the source digital video that is marked with object associations by the creator user is also posted to one or more portals (e.g., home page corresponding to an individual account of a social networking service). This provides an additional avenue for accessing the marked digital video. For instance, the parent marked video URI and/or one or more child marked video URIs, in association with descriptive information, may be posted to a location (e.g., home page to an individual's account on a socially networked service provider) that provides access to the source digital video that is marked with one or more object associations corresponding to one or more marked moments.

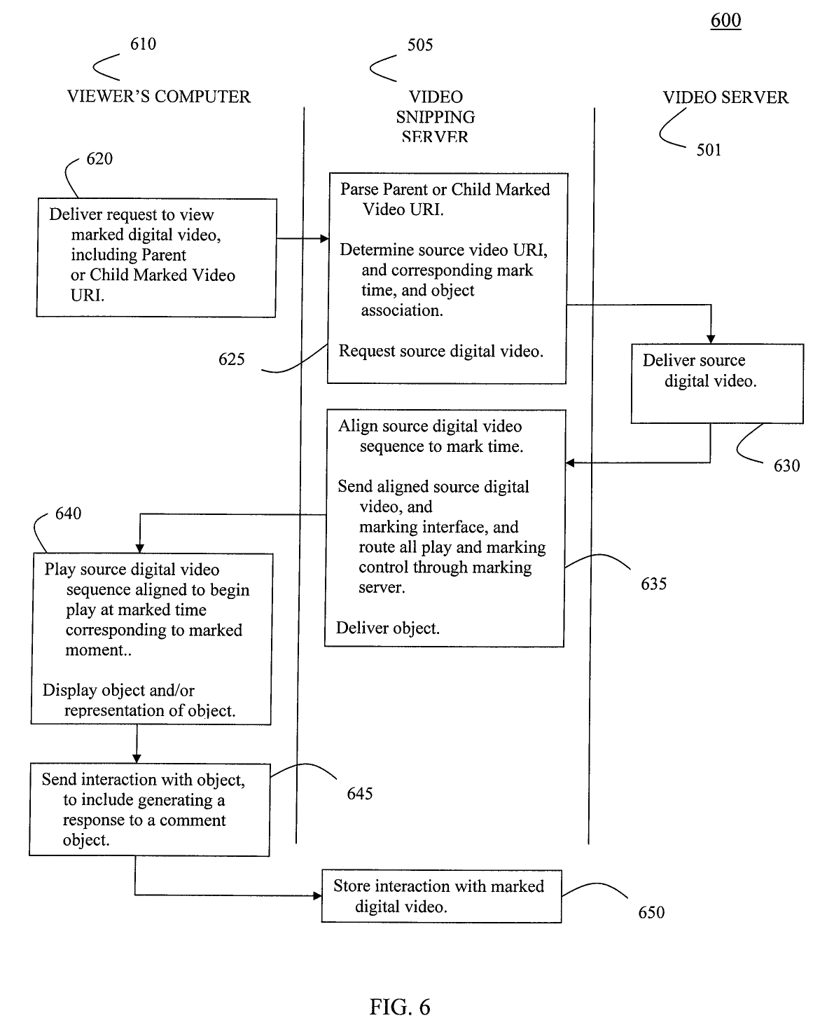

FIG. 6 is an exemplary data flow diagram 600 illustrating the flow of information when implementing a method and/or system for requesting delivery of a marked video that includes information relating to an object association with a particular moment in time, in accordance with one embodiment of the present invention. For instance, in one embodiment, the data flow diagram 600 illustrates the flow of information as implemented by system 100 of FIG. 1. However, it is contemplated that in still other embodiments of the present invention system 100 of FIG. 1 is able to implement other variations of data flow for purposes of requesting delivery of marked videos.

Information flows between three separate parties within data flow diagram 500 to include the video server 501, the video snipping server 505, and viewer's computer 610. As shown, the video server 501 acts as the source of the source digital video, as previously described. In one embodiment, the video snipping server 505 does not store the source digital video, whereas in other embodiments, the video snipping server 505 does store internally the source digital video. The viewer's computer 610 is used to request marked digital videos, or video snips.

In block 620, the viewer is able to generate a request to view a marked digital video. For instance, the viewer is a recipient of a notification of the marked digital video, as previously described. In other instances, the viewer is able to discover the marked digital video, such as through searching that is based on object associations relating to the marked digital video. Specifically, the viewer is able to select (e.g., click a link) a parent or child marked URI associated with the marked digital video. For instance, the parent or child marked URIs may have been posted to the creator user's home page corresponding to an individual account of a socially networked service provider. The marked URI links the viewer's computer 610 to the video snipping server, and more specifically to the file containing information used to generate the marked digital video (e.g., video snips) as presented to the viewer user.

As such, at block 625, the videos snipping server 505 is able to parse out the parent or child marked URI. From the information contained in the file location associated with the marked URI, the video snipping server is able to determine source video URI information, and a marked time in the timeline of a marked moment that is requested by the user. Additionally, the video snipping server is able to determine information related to the object association corresponding to the marked moment. All of this information is used to generate the video snip delivered to the viewer's computer 610.

In block 625, the video snipping server 505 requests the source digital video from the video server 501 using the source digital video URI. At block 630, the source digital video is delivered to the video snipping server. In this manner, the video snipping server 505 acts as the intermediary source of the source digital video in relation to the viewer's computer 610.

At block 635, the video snipping server 505 aligns the source digital video to the marked time of the marked moment associated with the marked URI requested by the viewer. The aligned source digital video as well as the video player/marking interface, previously introduced, are delivered to the viewer's computer 610, and more specifically to the browser of the computer 610 in one instance. In this manner, all the video player and the marking controls are handled by the video snipping server 505. Optionally, the object, a representation of the object, or information related to the object association is delivered to the viewer's computer 610 for display. In this manner, all the marked moments, and/or information related to such, are able to be displayed along with the marked digital video.

Block 640 shows that the source digital video is aligned to pause play or begin play at the marked time corresponding to the marked moment requested by the viewer, along with corresponding object associations. That is, the viewer's computer 610 displays the source digital video aligned to the marked time, as well as the video player/marking interface. In that manner, the viewer is able to send video control commands to the video snipping server, such as requesting the skipping to various other marked moments.

Also, the viewer is able to create additional marked moments within the marked digital video, or to create a new marked digital video based on either the original marked digital video, or the source digital video. Specifically, in block 645 the interface allows the viewer to interact with a specific marked moment. For instance, the viewer is able to leave a comment, or respond to a previously made comment in connection with a marked moment. As such, the interaction is delivered to the video snipping server 505 and stored with the other information relating to the marked digital video in a corresponding file, such as that accessed through a parent or child marked URI.

Caption and Friend Association with a Moment in Time in a Video

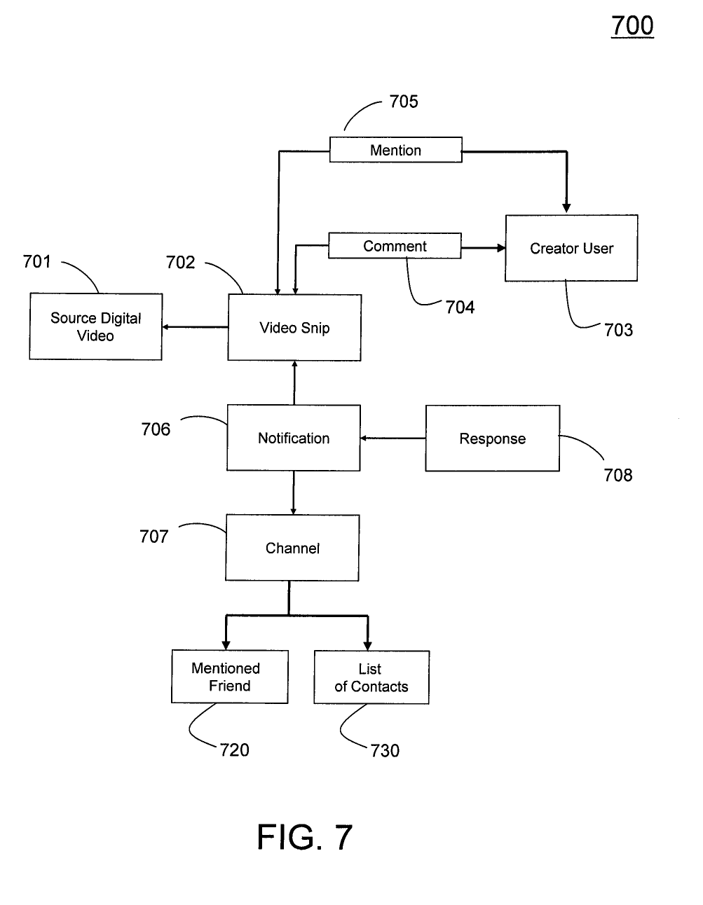

Embodiments of the present invention as disclosed in FIGS. 1-6 and its accompanying description disclosing the creation of a marked video snip associating an object with a particular moment or point in time in a source digital video are applicable to embodiments of the present invention facilitating the association of textual information and/or friend mentions with a marked moment in a source digital video as disclosed in FIGS. 7-11 through a creator user's computer. Consistent with FIGS. 1-6, the caption association and friend mentions are instances of the object association, in one embodiment of the present invention. More particularly, embodiments of the present invention allows a creator user to associate text and/or a friend mention to any moment or point in time in a digital video. Briefly, a unique identifier identifying the marked time of a particular moment in time is assigned. In addition, textual information and/or friend mentions, and user data are stored in a relational database to provide access to the marked moment and associated text.

In another embodiment of the present invention, the functionality of displaying text within a video may be ported onto user-generated websites and/or blogs. In still another embodiment of the present invention, expanded context-to-video content across various platforms (e.g., mobile devices) is enabled so that registered users receive notice of text and identification of the provider of such text across the various broadcasting channels (e.g., Facebook®, Twitter®, Tumblr®, Friendfeed®, etc.).

In still another embodiment of the present invention, once text is associated to a point in a video timeline, the recipient of a notification of the marked digital video receives on his or her device (e.g., a mobile device, a standalone computer, etc.) a hyperlink to the video link and any associated text via short message service (SMS) messaging, or any suitable notification medium. In the case of SMS messaging, the viewer can reply via SMS in-line to any messages received and thus enable threaded conversations across the mobile platform.

In one example used for purposes of illustration of the implementation of a video snipping service provided in system 100 of FIG. 1, a creator user has an account with the video snipping service. The service may be implemented through a network website that displays embedded videos hosted by third party video-sharing websites, and their associated comments linked to time stamps within the videos. Through this video snipping service, the user has access to user generated video snips, other video snips that were shared with the user, and video snips that were marked with that user, or that mentioned the user.

In one scenario, the creator user may be viewing a video hosted on a third party video hosting website, and would like to share a portion (e.g., video snip) of the video with other participants. Instead of sending the link to the entire video via the third party website, the creator user is able to direct the users to a specific portion of the video (e.g., video snip). The user is able to determine the staring time of the video snip. The user may also define an ending time of the video snip. In addition, the user is able to make an association between commentary provided by the user and a marked moment in time of the video snip. Other viewers may respond to the original comment, or add additional comments to the video snip.

More specifically, the video snip includes the marked video URI that locates the marked video, or information enabling the generation of the marked video. In one embodiment, the marked video is embedded from the third party video source website, but the text comments associated with the marked moments in the video snip are hosted on the video snipping network website providing video snipping services.

FIG. 7 illustrates the relationship 700 amongst a creator user 703, a mentioned friend 720, a video snip 702, and a source video 701, in accordance with one embodiment of the present invention. The discussion in this section focuses on the marking of the source digital video with a caption or commentary, or a friend mention. In addition, the relationships illustrated in FIG. 7 is applicable to associating, interacting and sharing a marked digital video that includes object associations with corresponding marked moments.

In particular, the creator user 703 interacts with the video snipping service to mark specific moments in time of a particular source digital video 701, as previously described in FIGS. 1-6. Specifically, the creator user 703 is able to identify a marked moment in the timeline of the source digital video 701 and define an object association that comprises a caption or commentary 704 related to the marked moment. For instance, creator user 703 wishes to share a video snip 702, and its commentary associations 704 with one or more recipients. The commentary associations include a comment 704 regarding the video snip 702. As such, a textual comment 704 is associated with a marked moment in a video, wherein the marked moment is matched with a marked time in a timeline of the video. The video snipping service (e.g., accessed through a web site) allows the creator user 703, identified by a video snipping service account, to insert textual commentary for purposes of sparking discussion in a social network.

Additionally, in another embodiment, the marked moment has an independent object association in the form of a friend mention 705. The friend mention or association indicates that a particular individual is found within the context of the marked moment. In another embodiment, the individual may be associated with a particular comment or response. The friend mention, as an object association, is created as a connection between the video snip 702 and the friend 720 that was marked or mentioned in the marked digital video, or video snip 702. By identifying a friend 720 within the video snip, notification of the marked video or video snip may be delivered to the mentioned friend. For instance, the friend may be identified through the use of markup language that textually identifies a friend (e.g., @username), and a way to communicate with that friend. Also additional account metadata can be generated relating to that friend. In this manner, additional discussion between the mentioned friend, the creator user 703, and any other parties may be instigated relating to the marked moment, as well as the commentary provided by the creator user 703. Account metadata can be generated relating to that friend.

In order to share the video snip 702 with other viewers in the list of contacts 730 or a mentioned friend 720, a notification message 706 is sent via a channel 707. The channel 707 is the medium on which the message is sent or broadcast. Examples of channels 707 include, but are not limited to, email, SMS, communication through social networking websites (e.g., Facebook®), and communication through micro-blogging services (e.g., Twitter®). As discussed previously, a notification 706 may be any message sent from the video snipping system via any broadcast channel 707 that provides an avenue to the marked digital video that is marked with commentary and/or friend mentions.

A response 708 from any viewer of the marked digital video or video snip 702 is a reply to any of the notifications 706 that are received by the video snipping system, and can be tracked to facilitate cross-posting and comment generation, and viewer user interactions which generate additional object associations (e.g., a viewer user who identifies a socially networked ‘friend’ in a marked video and marks this friend through viewer interaction features allowing for this). The response is tied to the commentary provided by the creator user 703, in one embodiment. In some implementations, a response 708 may also be received by the creator user 703. In still other embodiments, the viewer of the marked digital video or video snip 702 is able to generate an original comment in the form of a response 708 that is then associated with the marked moment. As an example, comment/response monitor 270 of the video snipping system 101 is configured to monitor comments, replies, and responses.

In one illustrative embodiment of the present invention, video snips 702 and associated comments 704 and mentions 705, as well as other object associations, may be stored in a relational database. There is a one-to-many relationship between video snips 702, mentions 705, comments 704 and users 703. For instance, one video snip 702 may be related to multiple mentions 705, comments 704, and friends 720.

FIG. 3B illustrates the structure of the video snip field (VSF) 300B in accordance with an illustrative embodiment of the present invention. VSF 300B is one exemplary instance of the VSF 300A, in one embodiment, but is tailored to an object comprising textual commentary. The information described and disclosed in VSF 300B is equally applicable to information related to other objects, such as a friend mention. More particularly, VSF 300B facilitates access to a marked digital video through the video snipping service. In one embodiment, VSF 300B is accessible through a parent or child marked video URI.

VSF 300B includes components of a video snip, or marked digital video. For instance, VSF 300B is comprised of a unique id 340, a creator id 350, the video snip start time 360, a textual caption 370 that is associated with the marked moment defined by the start time 360, and the source video URI used to locate the associated source digital video. Additional information may be included, such as an end time, responses to commentary, information related to additional marked moments corresponding to other video snips, and any other meta data useful in defining the marked digital video. In particular, the marked digital video is identifiable by the information contained in VSF 300B, in one embodiment.

In particular, a unique id 340 is assigned to the video snip and is provided by the video snipping service, so that the source video is uniquely identified. As previously described, the unique id 340 includes or can be mapped to the source video URI.

In one embodiment, the creator id 350 is based on the current web browser session. For instance, the creator id 350 comprises a user identifier associated with the currently signed in user to the video snipping service. In another implementation, the unique user id 350 comprises a user identifier of the viewer generating a reply to an original comment.

The video snip start time 360 marks the beginning of the video snip 702. For instance, the start time 360 is the marked time corresponding to the marked moment. In addition, the end time (not shown) marks the end of the video snip 702, as determined by the creator user 703 of the video snip 702.

The source digital video URI 380 provides access to the source digital video. For instance, URI 380 is the web address of a video hosting service where the video is located, in one implementation.

Also, the VSF 300A includes a representation of the object, or the caption 370 in this case. The caption provides commentary related to the marked moment, which is shared with members of one or more social networks. A discussion may be sparked in relation to the marked moment and the commentary associated with the marked moment.

In one embodiment, the information relating to the marked digital video, such as information included in VSF 300B, is located in a file location defined by a marked video URI associated with the video snipping system 101. For instance, the file may be located in data store 102 of FIG. 1. As such, by requesting the marked video URI, the marked digital video, or information leading to the generation of the marked digital video, is accessed. The marked digital video may be associated with one or more parent and child marked video URIs, as previously described. A viewer requesting to view marked moments may provide either the parent or child marked video URI.

In some embodiments, rather than storing information internally at the video snipping service, the information included in the VSF 300B is written to the source file of the source digital video via that source video host server's API, or in those cases where video hosts do not offer an API, to sync the text to the video's timeline. As such, the information included in VSF 300B may be stored in either or both of the data store of the video snipping service and the original source file of the source digital video.

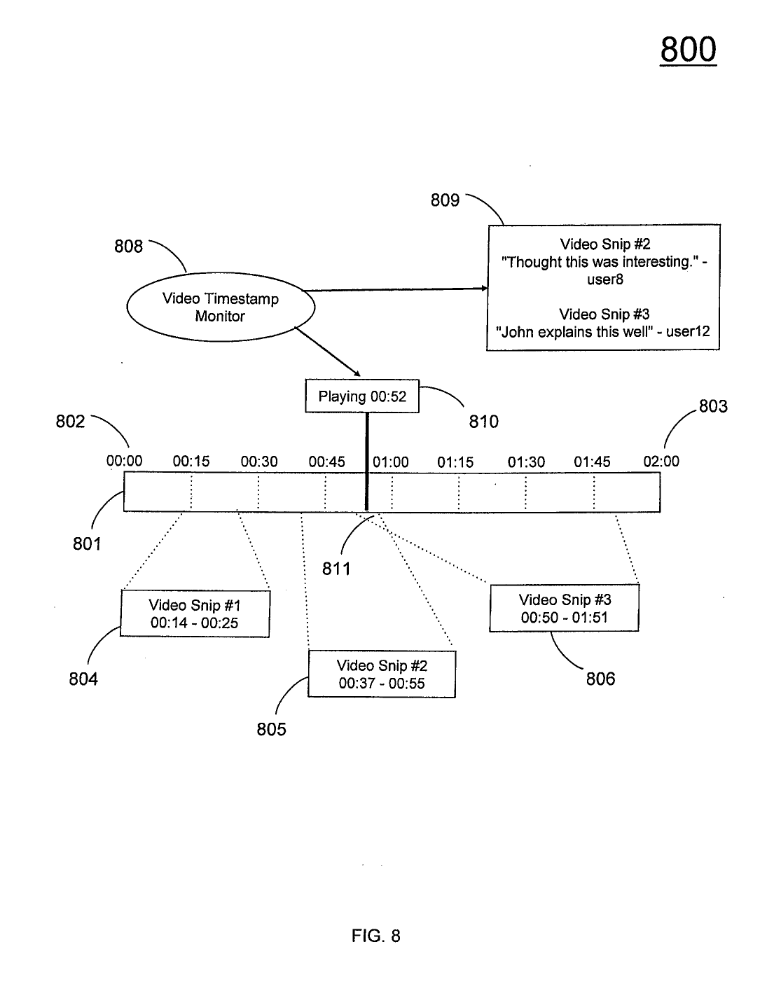

FIG. 8 illustrates the relationship between a source digital video 801 and associated video snips, in accordance with one embodiment of the present invention. As shown, the source digital video 801 has been marked with multiple video snips, each of which is associated with a corresponding marked moment, as previously described. Although FIG. 8 is provided within the context of a marked digital video having marked moments associated with textual commentary, the illustration of the video snips is equally applicable to illustrating a marked digital video having marked moments associated with any object, or object representations, or information related to an object, in other embodiments of the present invention.

The source digital video is being played for a viewer through the viewer's computer. The source digital video is two minutes (2:00) long, but as delivered begins play at a corresponding marked moment or start time of a video snip, as requested by the viewer. For instance, the video player of the video snipping service may have started play at the second video snip 805. Currently, the source digital video is being played fifty-two seconds (00:52) into the video.

As shown in FIG. 8, a timestamp monitor is able to monitor and track at which point in time the video is being played. The timestamp monitor may be internally located at the video snipping service, or may be located at the source video host server. In addition, the timestamp monitor may be located in a browser of the viewer's computer in the video player/interface controller that is delivered along with the marked digital video.

As shown in FIG. 8, the source digital video 801 may have several video snips to include a first video snip 804, a second video snip 805, and a third video snip 806. Each video snip 804, 805, 806 has a starting time, as defined by the creator user. For instance each start time is associated with a corresponding marked time of a marked moment. Also, each video snip 804, 805, and 806 has an ending time that may be defined by the user. As a default, the end time is the end time of the source digital video (e.g., 2:00). For instance, video snip 804 begins at 00:14 seconds and ends at 00:25 seconds; video snip 805 begins at 00:37 seconds and ends at 00:55 seconds; and video snip 806 begins at 00:50 and ends at 01:51. In addition, a video snip may overlap in time with one or more video snips. As shown, the end of video snip 805 overlaps the beginning part of video snip 806.

The video timestamp monitor 808 monitors the timestamps, or marked times, within a timeline of a digital video 801 to determine what video snips 804, 805, and 806 are available. As such, the video timestamp monitor 808 passes to the viewer's computer information regarding what video snips 804, 805, 806 are available at a specific playing time 810.

In addition, the video timestamp monitor 808 in conjunction with the marked digital video assembler passes information regarding what comments are available for the video snips 804, 805, and 806. For instance, the video is being played at time 810, which is 00:52 seconds from the beginning of the source digital video. The play time falls within two video snips 805 and 806. As such, commentary for both video snips 805 and 806 may be displayed simultaneously with the video. As shown, the commentary 809 associated with video snip 805 states that “Thought this was interesting” for user8, and corresponds to a marked moment associated with video snip 805. In addition, commentary 809 associated with video snip 806 states that “John explains this well” and is provided by user12, and corresponds to a marked moment associated with video snip 806.

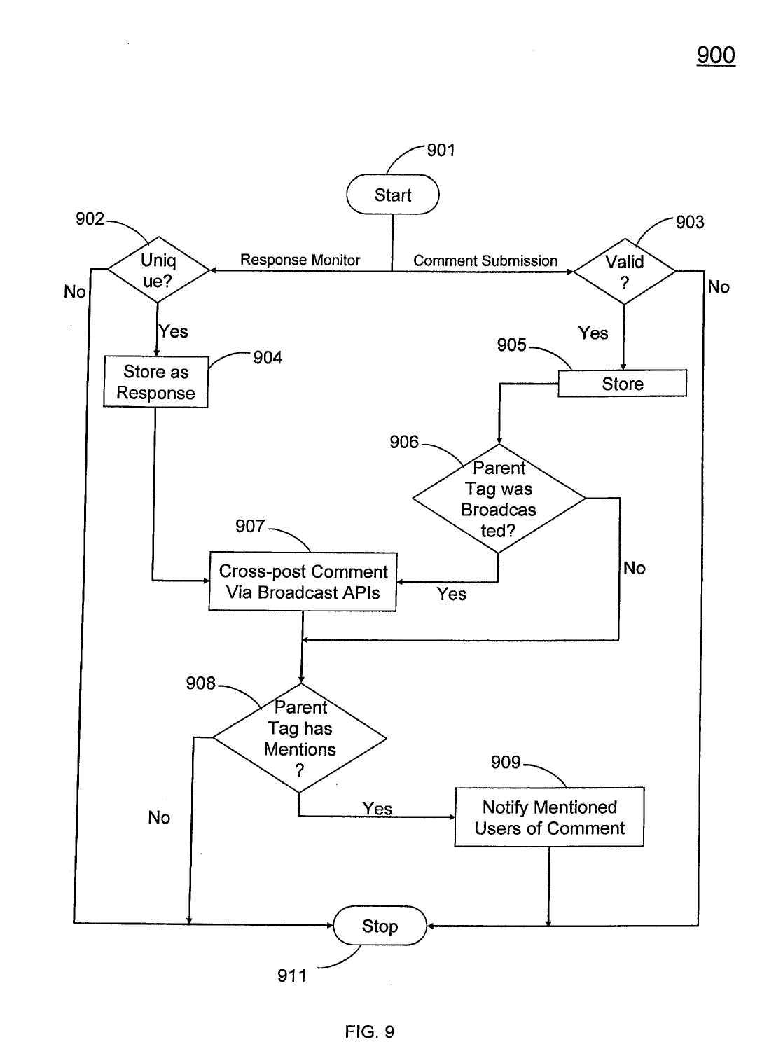

FIG. 9 is a flow diagram 900 illustrating the a method for submitting comments and monitoring responses to comments, in accordance with one embodiment of the present invention. The process shown in flow diagram 900 is performed by the comment/response monitor 270 of the video snipping system 101 of FIG. 2, in one embodiment. It is intended that the method shown in flow diagram 900 is exemplary for submitting comments and monitoring for responses, and that other methods are contemplated for submitting comments and monitoring for responses, as well as for submitting information related to objects associated with corresponding moments in time.

As shown in FIG. 9, a comment 704 is submitted 901 to the video snipping system. The original comment is typically submitted by the creator user 703 that is defining marked moments in the source digital video. Additionally, a friend mention may also be submitted, and treated similarly like comments, as described below in FIG. 9. The comment 704 is checked to see if it is valid, in decision step 903. For instance, the validation check includes verifying the user's credentials within the video snipping system (e.g., verifying they have an account) and verifying that the video snip 702 being commented on exists.

If it is a valid comment 704, then the comment 704 is stored 905 in the data store 102 of the video snipping system. If the comment 704 is invalid, then the process stops 911.

Next, it is determined whether the parent marked video URI associated with the video snip 702 was broadcasted 906 via a channel. That is, it is determined whether others have already received notice of the marked digital video. If the parent marked video URI was broadcasted, then the comment 704 is cross-posted 907 via the implemented broadcast channel's API (or APIs). That is, the comment is also cross posted through the same broadcast channels used to send notification of the marked digital video.

If the parent marked video URI was not broadcasted, or if the comment was cross posted, then the parent marked video URI associated with the video snip 702 is checked 908 for any other object associations, such as any friend mentions. If there are no friend mentions, then the process stops 911. On the other hand, if there are friend mentions in the marked digital video, then the mentioned users are separately notified 909 of the comment.

Also shown in FIG. 9 is the process used to monitor for responses to comments previously submitted. A response 708 is received over a channel 707. The response 708 is checked to determine 902 if it is unique within the video snipping system, or has been submitted previously. In one implementation, a response 708 is analogous to a reply on a channel 707 to a comment 704. If the response 708 is unique, it is stored 904 in data store of the video snipping system, and more specifically, the response 708 is stored in a file corresponding to the marked digital video, as previously described. The file provides information that is used to generate the marked digital video, and its corresponding commentary and responses. On the other hand, if the response 708 is not unique, then the process ends 911.

Further, after the response 708 is stored, the response 708 is then cross-posted 907 via the broadcast channel's APIs used previously to broadcast the notification and/or any separately broadcasted comments.

Once the response 708 is cross posted, then the parent marked video URI associated with the video snip 702 is checked 908 for any other object associations, such as any friend mentions. If there are no friend mentions, then the process stops 911. On the other hand, if there are friend mentions in the marked digital video, then the mentioned users are separately notified 909 of the response 708.

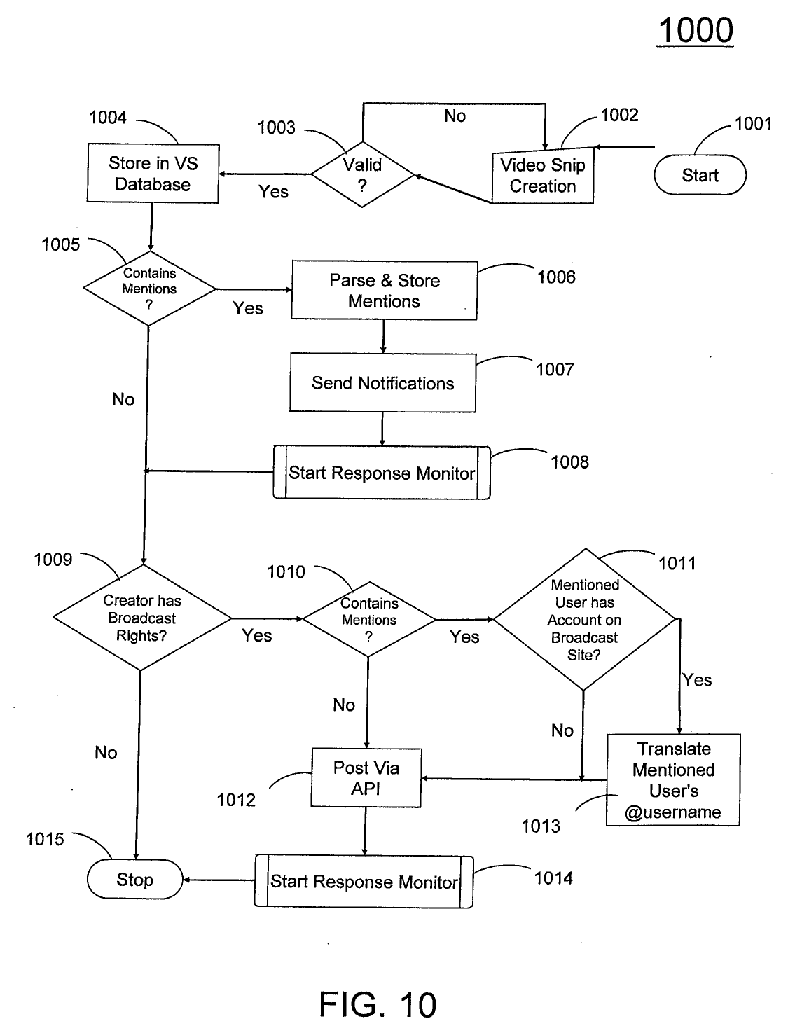

FIG. 10 is a flow diagram 1000 illustrating a method for creating a friend mention that is associated with marked moment in a source digital video, in accordance with one embodiment of the present invention. The process begins with the video snip 702 creation 1002. The video snip 702 is defined by a marked moment of a source digital video, as previously described.

The video snip 702 is validated 1003 to determine if there were any errors in the creation process. If there were errors, then the creation 1002 of the video snip 702 is repeated. On the other hand, if the video snip 702 created is valid 1003, then the video snip 702 is stored 1004 in the video snip data store. For instance, information used to generate the video snip, such as those contemplated in VSFs 300A and 300B, are stored.

Next, the video snip 202 is checked 1005 for friend mentions. A friend mention associates the marked moment of a video snip 702 to an identifiable friend in the marked moment. If there are mentions associated with the video snip 702, the mentions are parsed and stored 1006 in the video snip data store, such as for purposes of cross referencing to other video snips or other related information. As previously described, a notification is sent 1007 to listed contacts in the creator user's identified social networks.

In addition, the notification is sent 1007 to a start response monitor 1008 via a channel 707. Receipt of the notification by the start response monitor provides an alert that a mention 705 is associated with the video snip 702. In turn, this starts the response monitor 1008 to monitor for any responses 708 that are sent back via the channel 707, over which notification 707 were sent to listed contacts.

Thereafter, it is determined 1009 whether the creator user 703 of the video snip 702 has the appropriate broadcast rights associated with a particular channel 707 over which responses 708 or comments 704 are to be posted. For instance, it is verified that the creator use has an account with the social networking service providing the corresponding channel, over which the responses 708 and comments 704 are posted. The mentioning process 1000 stops 1015 if the creator user 703 does not have broadcast rights.

On the other hand, if the creator user 703 of the video snip 702 has broadcast rights, then the video snip 702 is checked again 1015 for mentions. Any mentioned friend is checked 1011 to determine if that friend has an account on the broadcast site, or the social network associated with the broadcast channel of interest. If a mentioned friend has an account on a broadcast site, then the mentioned friend's user identifier (e.g., @username) is determined 1013 and translated to the properly formatted identifier supported by the broadcast site, i.e., the social network associated with the broadcast channel. Thereafter, the friend mention 705 is posted 1012 to the mentioned friend's page or messaging interface via an API provided by the broadcast channel 707. Also, the notification 706 of the marked video containing the friend mention 705 is broadcasted over the same broadcast channel 707. On the other hand, if the user creator 703 has broadcast rights, but no mentions 705 are found to be associated with the video snip 702, then a notification 706 is posted 1012 via an API provided by the broadcast channel 707 alerting a recipient to the marked digital video.

The response monitor is started 1014 to monitor responses 708 sent by the broadcast channel 207 by various recipients of the notification 206. Delivery and treatment of responses was previously discussed in relation to FIG. 9.

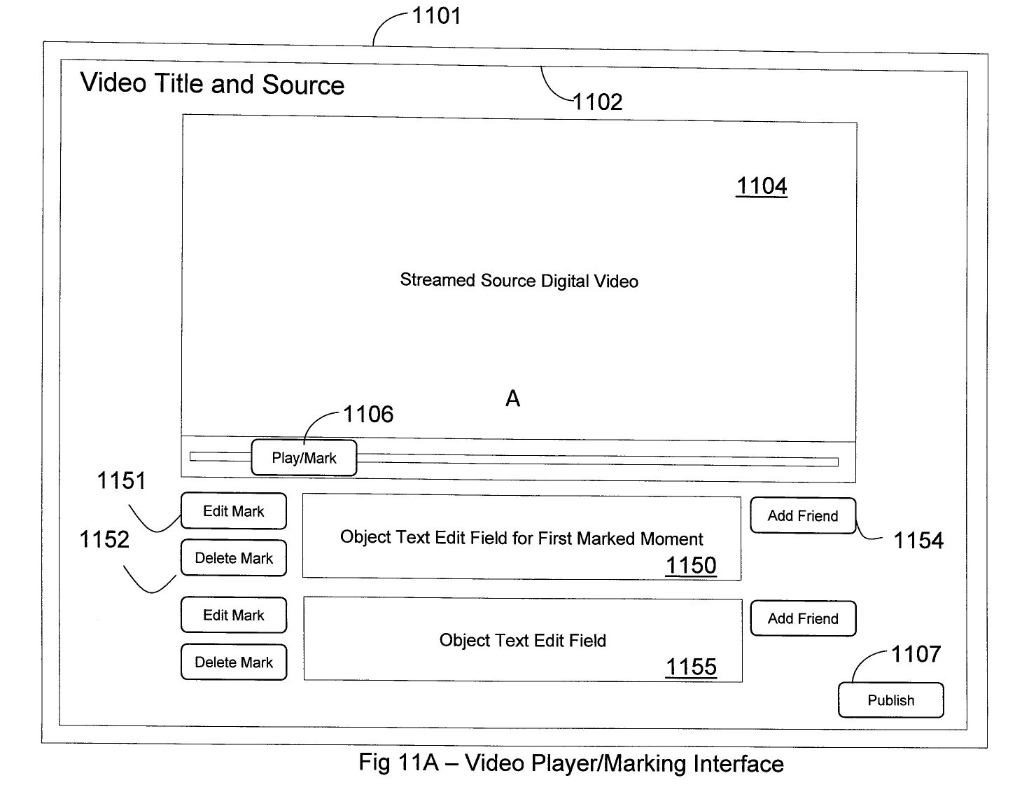

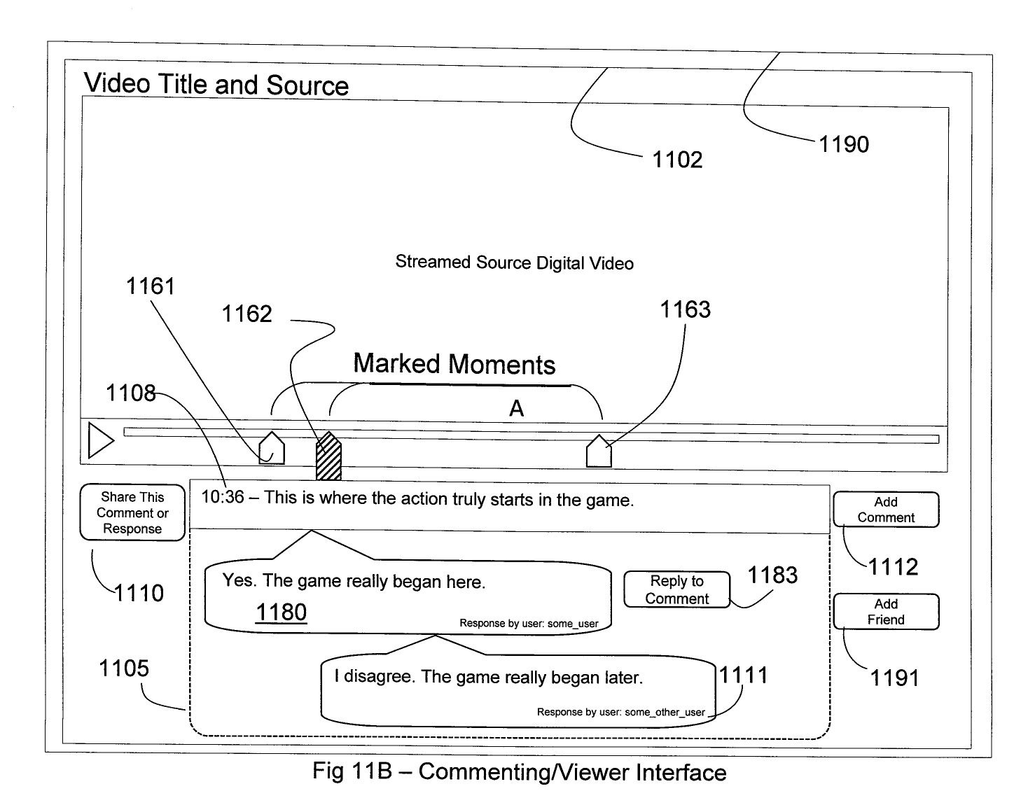

FIGS. 11A and 11B combined illustrate a creator user and viewer experience when marking a digital video with object associations. FIG. 11A provides an interface for marking a source digital video, and FIG. 11B provides a viewer interface for responding to comments, providing further commenting, and viewing the source digital video.

In particular, FIG. 11A is a screen shot of a website page 1101 streaming a source digital video for purposes of identifying marked moments and defining corresponding object associations, in accordance with one embodiment of the present invention. In addition, FIG. 11A illustrates a video player/marking interface that are used to control play of the source digital video, and to mark specific moments in time of the source digital video.

Prior to the presentation of the screen shots 1101 and 1190, the creator user is presented with a link to the website where the source digital video 1104 is located. That is, before any marking has occurred, the creator user is viewing the source digital video 1104 directly from the video host server. For instance, the source digital video stream 1104 may be located on a broadcast channel (i.e., YouTube®) or other video hosting website. Clicking on the video snipping service icon (e.g., browser bookmarklet) takes the creator user to the original start time within the video stream 1104.

As previously described, when a creator user wishes to first mark the source digital video stream 1104, the creator user activates an interaction with the video snipping service. Thereafter, screen shot 1101 as depicted in FIG. 11A is provided to the creator user for marking and viewing purposes, as will be described below.

FIG. 11A shows a screen-shot 1101 of a website page displaying a video player/marking interface 1102. The source digital video 1104 appears to the creator user 703 that is viewing the web page 1102 on the display of a creator user's computer 103. For instance, the creator user 703 is presented with the source digital video 1104 that is provided from a source video hosting service, through the video snipping system 101.

During the playing of the source digital video, the creator user 703 has the choice of assigning or creating new video snips by activating the marking button or interface 1106. That is, by activating the button 1106, a newly marked moment is defined within the source digital video for purposes of object association.

Additionally, in the video player/marking interface 1102 the ability to associate an object with marked moments is provided. For instance, in the case where the object association is a caption or textual commentary, entry field 1150 allows the user to define a commentary that is associated with the first marked moment. In addition, if the object has previously been defined and finalized, the “Edit Mark” button or interface 1151 when activated provides the ability to edit the commentary. In addition, the “Delete Mark” button or interface 1152 when activated provides the ability to delete the commentary, in one embodiment. In another embodiment, the “Delete Mark” button or interface 1152 deletes the marked moment and any corresponding object associations. Further, the entry field 1155 provides for additional object associations to be made with the first marked moment. For instance, a second comment may be associated with the marked moment.

Also, the “Add Friend” button or interface 1154 when activated provides the ability to associate or mention a socially networked, or any other user defined, friend as an object that is associated with a marked moment. Information related to the friend association is provided within the object text edit field 1150. For instance, a first friend is captured in a first marked moment of a source digital video. That first friend is mentioned, marked, tagged, or identified by the creator user as an object that is associated with the first marked moment. In addition, a second friend is captured in a second marked moment of the source digital video. That second friend is mentioned, marked, tagged, or identified by the creator user as an object that is associated with the second marked moment. In addition, multiple friends may be mentioned within a particular marked moment. The creator user mentions as many friends as he or she desires within the context of the source digital video, using an interface such as the button or interface 1154.

The user is also presented the ability to share the video snip using the publish button or interface 1107. For instance, the video snip, or more specifically, notifications of the video snip with a link to the video snip, is published through another website, such as a social networking site e.g., Facebook, content aggregators site, e.g., Friendfeed, and status update sites, e.g., Twitter, in one embodiment. That is, notifications are provided through the messaging features provided by those social networking sites.

FIG. 11B is a screen shot of a website page streaming a marked digital video and a viewer user interface used to control play and interaction with marked moments in time, and to mark additional moments in time of the marked digital video, in accordance with one embodiment of the present invention.

As previously described, each video snip is assigned a start time corresponding to the marked time, within the source digital video stream 1108. For instance, as shown in FIG. 11B, three video snips are shown in the screen shot 1190 showing the same video playing/marking interface previously introduced 1102. Each of the video snips correspond to a marked moment. For instance, a first marked moment corresponding to tab 1161 is shown near the beginning of the video, a second marked moment corresponding to hashed tab 1162 is shown that occurs shortly after the first marked moment 1161, and third marked moment corresponding to tab 1163 occurs near the middle of the source digital video.

As shown in FIG. 11B, the video player/marking interface 1102 is displaying to a viewer the second video snip corresponding to the second marked moment associated with tab 1162 for viewing, responding to comments, and marking purposes. The second video snip corresponding to hashed tab 1162 starts at time ten minutes and thirty-six (10:36) seconds after the start of the source digital video.

In particular, a comment 1108 (“This is where the action truly starts in the game.”), originally provided by the creator user, is displayed in comment/reply window 1105 that is associated with the second marked moment corresponding to hashed tab 1162. Additionally, a first response 1180 (“Yes. The game really began here.”) is provided that responds to and agrees with the original comment 1108. Also, a second layer response 1111 (“I disagree. The game really began later.”) is provided that responds to and disagrees with both the original comment 1108 and the first response 1180.

Additional information may be provided by the viewer user, in accordance with one embodiment of the present invention. All this information is stored in relation to the previously associated information, such as that found in VSF 300A and VSF 300B. In one implementation, the additional information is included with the previously collected information related to the source digital video that is marked with one or more marked moments. The distribution of the additional information of a viewer user that provides added associations within the marked digital video originally marked by a creator user is distributed across various platforms, as previously described. In one implementation, the additional information presented within the context of the marked digital video is distributed to the creator user's distribution list. In another implementation, the additional information presented within the context of the marked digital video is distributed to the viewer user's distribution list. In still another implementation, the additional information presented within the context of the marked digital video is distributed to a combination of both the creator user's and the viewer user's distribution lists.

For instance, additional replies to comments may be provided via button or interface 1183. Also, new and/or additional comments or text generated either by the creator user 703 or viewer may be provided via button or interface 1112. Furthermore, individual comments and/or responses may be shared with other users via button or interface 1110.

Also, the viewer user may also mention, mark, label, associate, or tag 1191 their socially networked, or other user defined, friends, such as those captured within marked moments and/or other frames and images in the source digital video. Furthermore, individual comments and/or responses may be shared with other users via button or interface 1110. For example, the example previously described for mentioning and/or adding friends by a creator user provides context for mentioning and/or adding friends by a viewer user. In the example, the creator user has mentioned and/or added a first friend as a first object in association with a first marked moment, and a second friend as a second object in association with a second marked moment. Through the “Add Friend” button or interface 1191, or any other interface suitable for mentioning and/or adding friends, a viewer user is able to mention and/or add additional friends to the source digital video that was marked by the creator user. For instance, in one implementation, the viewer user is able to add a third friend that is also captured in the first marked moment. As such, two friends are mentioned in association with the first marked moment, a first friend mentioned by the creator user, and a third friend that is mentioned by the viewer user. In another implementation, the viewer user is able to create a new marked moment having a new object association. For instance, the viewer notices that a fourth friend is captured in a third marked moment, where the fourth friend as well as the third marked moment were not originally marked by the creator user. In this case, the viewer user is able to mark the third marked moment, and provide an object association with the third marked moment. In the present implementation, the object association is a friend mention that associates a fourth friend with the third marked moment. These new friend associations, as previously described, is included in the object associations (e.g., friend associations) that define marked moments for the marked digital video.

Geo-Location Association with a Moment in Time in a Video

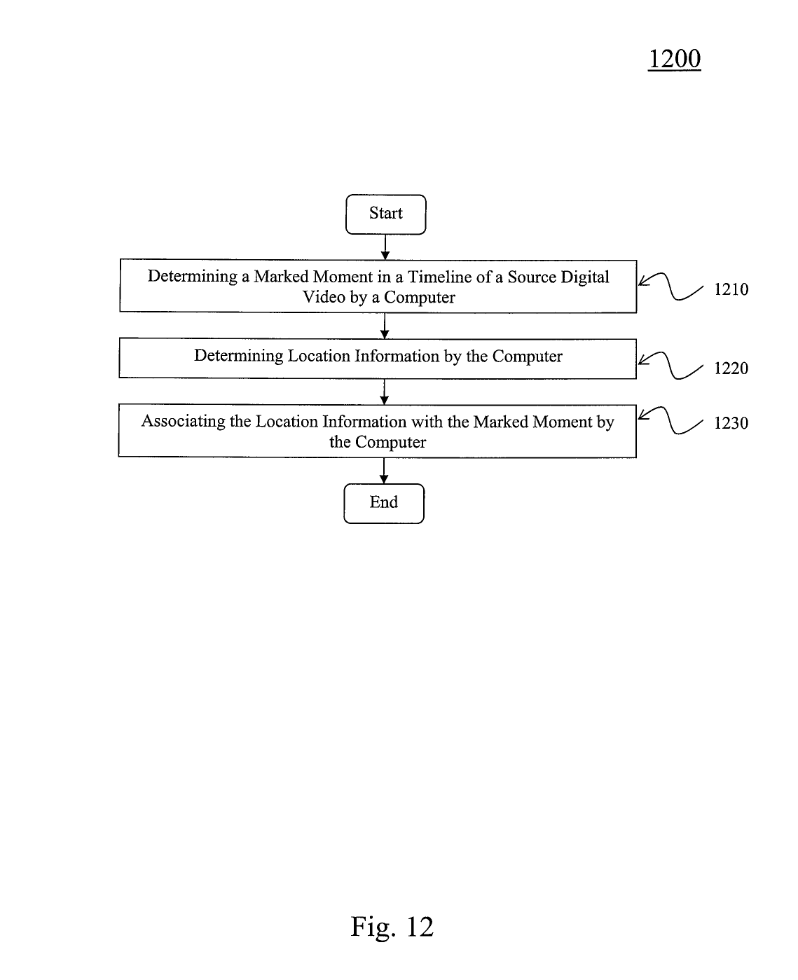

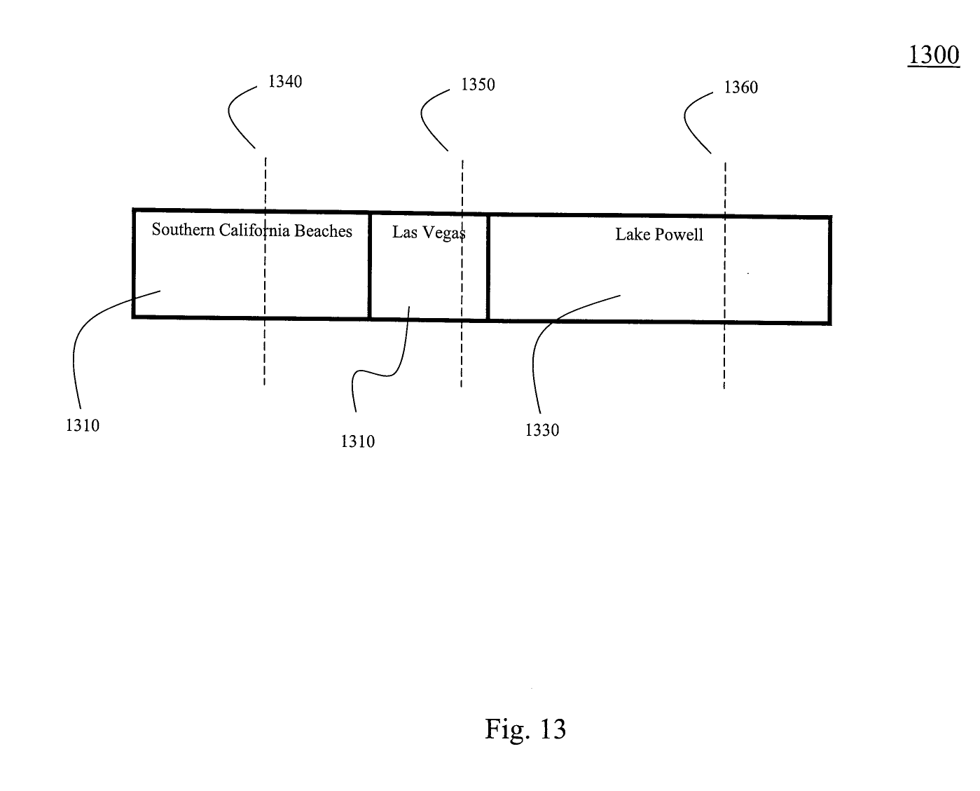

Embodiments of the present invention as disclosed in FIGS. 1-11 and its accompanying description disclosing the creation of a marked video snip associating an object with a particular moment or point in time in a source digital video are applicable to associating location information with a marked moment in a source digital video as disclosed in FIGS. 12 and 13.

FIG. 12 is a flow diagram 1200 illustrating a method for marking video with location information, in accordance with one embodiment of the present invention. The method outlined in flow diagram 1200 is implementable within video snipping server 101 of FIG. 2, in one embodiment. In another embodiment, the method outlined in flow diagram 1200 is implementable within the creator user's computer. In still another embodiment, the method outlined in flow diagram 1200 is implementable within a combination of the video snipping server 101 and the creator user's computer.

As shown in FIG. 12, the method includes determining 1210 a marked moment of a source digital video by a computer. Specifically, the marked moment comprises a moment defined within a sequence of frames defining the source digital video. The moment may be comprised of one or more frames or images within the source digital video, and cover a period of time. As an example, the marked moment may comprise a single frame or image at a precise instant of time within the timeline of the source digital video. In another example, the marked moment may comprises multiple frames or images that cover a period of time within the timeline of the source digital video, such as covering one half of a second of video.

In addition, the marked moment corresponds to a marked time within the timeline of the source digital video. As such, by aligning the source digital video to the marked time, the marked moment is displayable. For instance, the timestamp monitor 220 of the video snipping system 101 is configured to determine a marked moment that corresponds to a marked time. As previously described, the marked time is requested from the source video server hosting the source digital video by the timestamp monitor, in one instance, or can be measured by the timestamp monitor, in another instance.

The source digital video is hosted by a video server. As such, a globally unique video identifier is determined, such that the source digital video is accessible through the video server. In one instance, the globally unique video identifier comprises a URI, or a source video URI. For instance, a video controller 210 determines the globally unique video identifier that identifies the source digital video.

Location information is determined 1220 by the computer. For instance, the location information comprises geographic information (e.g., latitude and longitude) related to the area within which the video was captured. The geographic information may be of any format (e.g., latitude and longitude) suitable for conveying a location within a space (e.g., world). Put another way, the geographic information is associated with a location of an object that is captured within the video. In another instance, the location information includes global positioning system (GPS) position information.

In one embodiment, the location information comprises a place name. For instance, instead of using a predefined measurement system to define a location, a name that is associated with the geographic location is used as location information. As an example, though a video may be capturing images in and around the Washington Monument, rather than define a geographic position (e.g., latitude and longitude), the place name, “Washington Monument,” may be used as location information.

In another embodiment, the location information comprises a user generated name that relates some personal association with a marked moment and/or the entire source digital video. That is, the location information is related to the geographic location where the video and/or marked moment was captured, but provides an additional association to that geographic location. For example, the marked moment may have location information that describes the first place where a couple met. As such, this location provides a personal emotional connection to the marked moment and/or the marked video. In another example, the geographic location may be the foyer of a historic building, but rather than label it as such, the location information describes a historic event that took place at the foyer, such as a famous duel between two citizens. As such, the location information provides a labeling of an event that occurred at a particular geographic location. These are some examples of how location information, other than strict geographic coordinates, may be used to define and describe a marked moment and/or a marked video.

In one embodiment, the location information is defined by a user. For instance, the user may interact with the marking interface to define the location information. As such, the user inputs data, such as geographic information (latitude and longitude), or place name, for use as the location information. As an example, the location information may be associated with an object captured within one of the images of the source digital video. Though the video capturing device may be miles away from the object, such as a mountain peak when taking a scenic video, the location information may pertain to the object of interest, such as the geographic location of the mountain peak, which is defined by the user.

In another embodiment, the location information is discoverable. For instance, the location information is associated with the device capturing the source digital video, in one embodiment. That is, the location information comprises geographic information associated with the device at the instance in time that the source digital video is being taken. More specifically, geographic information determined by the capturing device, and designating the geographic position of the capturing device when capturing the source digital video, may be read and imprinted as meta data to the source digital video. As such, geographic information is included and associated with the source digital video.

In addition, the location information that is discoverable may pertain to an object captured within the source digital video. Using the previous example of a scenic movie, images and/or objects within images may be recognizable and associated with geographic information. For instance, the video snipping server may recognize certain objects captured within the source digital video and deliver location information suggestions through the marking interface returned back to the creator user.

In one embodiment, individual frames or images, or a small set of frames or images, within the source digital video is associated with location information. For instance, the individual or set of frames may be associated with meta data indicating the geographic position of the capturing device when capturing the image and/or frame, in one instance. In another instance, the geographic position is associated with an object captured within one of the images of the source digital video. As previously described, the location information pertaining to the individual or set of frames may be user defined or discoverable.

Also, the location information is associated with the marked moment by the computer, in one embodiment. That is, the association between the location information and the marked moment defines a searchable and identifiable relationship. In another embodiment, the location information is associated with the source digital video that is marked, or the marked video snip comprising a subset of the source digital video beginning at a start time of the marked moment. For instance, the marking module 230 is configured to associating the location information with the marked moment.

FIG. 13 is an illustration of a source digital video 1300 marked with one or more marked moments, where the source video stitches together separately taken videos, in accordance with one embodiment of the present invention. As an example, the source digital video 1300 is a vacation video and stitches together three vacation movies taken at three different locations. The videos may be associated with one vacation, or a series of vacations.

As shown the first section 1310 of the source digital video 1300 includes movie or motion scenes taken at Southern California beaches. The second section 1320 includes movie scenes taken in Las Vegas, and the third section 1330 includes movie scenes taken from a vacation in Lake Powell, Ariz.

Three marked moments are included in the source digital video 1300. For instance, marked moment 1340 includes location information related to Southern California beaches (e.g., movie images taken from Venice Beach, Calif.), marked moment 1350 includes location information related to Las Vegas (e.g., a place name for a casino), and the third marked moment 1360 includes location information related to a location at Lake Powell.

As such, although the source digital video 1300 includes separately taken videos, each pertaining to different vacation locations, the markings within the source digital video help give the video relevance. That information included in the markings is searchable and can be grouped together with other videos having similar object associations. For instance a viewer searching for movies with images taken at Bullfrog Marina in Lake Powell will discover the marked video snip including the third marked moment 1360, regardless of the superfluous inclusion of the beach images, and Las Vegas images.

Information is collected and/or delivered to a video snipping system for purposes of distributing the source digital video marked with marked moments and object associations, such as location information associations. That information includes the globally unique source video identifier, the marked time of the source digital video that corresponds to the marked moment, any object associations with the marked moment (e.g., location information), and any other related information. This facilitates the gathering of additional related information that helps define and mark the marked moment through a video player/marking interface, as previously described, as well as distributing the marked video to requesting viewers. For instance, a creator user may deliver the location information and any other information back to the video snipping server through the video player/marking interface. Also, a viewer user may view and add additional information to the marked video through the same or similar video player/marking interface.

The video snipping server stores the information in a marked video snip file that comprises the globally unique source video identifier, the marked time of the source digital video that corresponds to the marked moment, any object associations (e.g., location information) with the marked moment. In that manner, the server is able to generate and deliver the marked video snip back to a requesting computer of a viewer, where the source digital video is aligned to the marked moment ready for playing, and where any object associations may be also displayable.

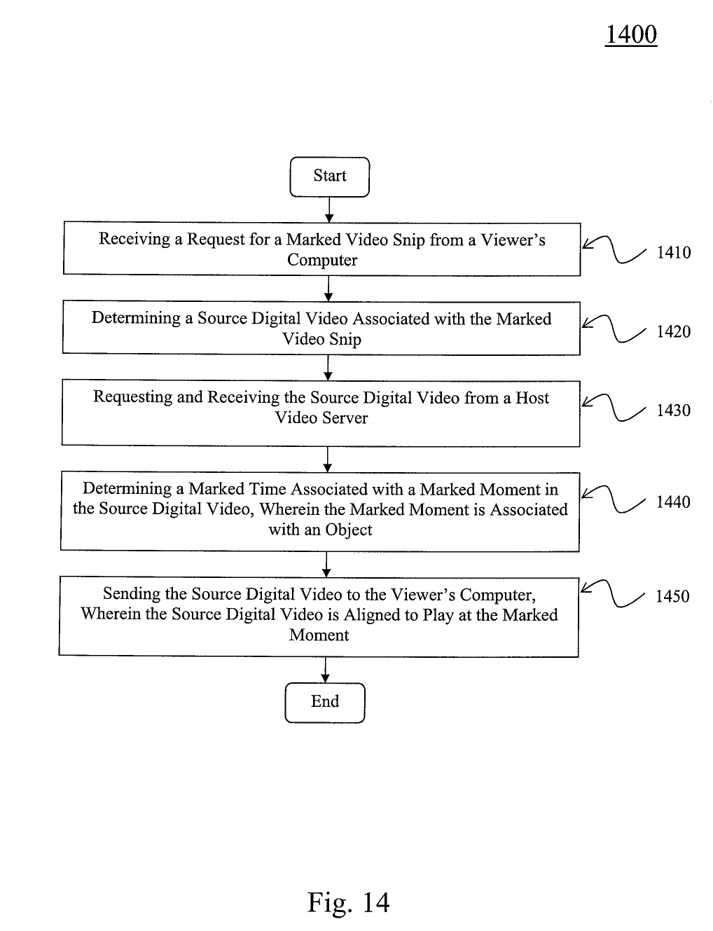

FIG. 14 is a flow diagram illustrating a method for distributing video marked with location information, in accordance with one embodiment of the present invention. The method outlined in flow diagram 1400 is implementable within the video snipping server 101 of FIG. 2, in one embodiment. In another embodiment, the method outlined in flow diagram 1400 is implementable within the creator user's computer. In still another embodiment, the method outlined in flow diagram 1400 is implementable within a combination of the video snipping server 101 and the creator user's computer.

As shown in FIG. 14, a request is received 1410 for a marked video snip from a viewer's computer. For instance, the request includes information providing access to a file maintained by the video snipping server. As previously described, the request may include a parent or child URI.

A source digital video is determined 1420 that is associated with the marked video snip. Specifically, the file includes information providing access to the source digital video that is hosted by a video server. For instance, a globally unique video identifier (e.g., a URI) to the video server is determined. Thereafter, the source digital video is requested and received 1430 from the video server. In that manner, the video snipping server can act as the intermediary source of the digital video, as it distributes it to the viewer's computer.

The file also includes a marked time in the source digital video, that is determined 1440, such as by the video snipping server. The marked time is associated with a marked moment. Further, object associations are included in the file, such that the marked moment is associated with an object, or a representation of the object, such as location information.

As such, the video snipping server is able to deliver the source digital video to the viewer's computer. Further, the digital video is aligned to play at the marked moment on the viewer's computer. In that manner, the request for the video snip returns the digital video aligned to play at a point in the video that is of interest to the viewer, the marked moment. In addition, the viewer is able to interact with the one or more marked moments contained in the video, as well as provide other marked moments within the source digital video.

Exemplary claims to marking video with location information is disclosed, as follows:
1. A method for marking video, comprising:

determining a marked moment of a source digital video by a computer;

determining location information by said computer; and

associating said location information with said marked moment by said computer.
2. The method of Claim 1, wherein said determining a marked moment comprises:

determining a marked time in a timeline of said source digital video, wherein said marked time corresponds to said marked moment.
3. The method of Claim 2, determining a marked time comprises:

requesting said marked time from a video server hosting said source digital video.
4. The method of Claim 2, further comprising:

determining a globally unique video identifier for said source digital video from a video server hosting said source digital video.
5. The method of Claim 4, wherein said globally unique video identifier comprises a URI.
6. The method of Claim 4, further comprising:

sending said marked time and said globally unique video identifier to a video snipping server for storage;

receiving a video player/marking interface from said video snipping server; receiving said source digital video from said video snipping server, wherein said source digital video is aligned to said marked time; and

displaying said marked moment.
7. The method of Claim 6, further comprising:

receiving said location information as defined by a user through said marking interface; and

sending said location information to said video snipping server for storing as a video snip file comprising said location information, said globally unique video identifier and said marked time.
8. The method of Claim 6, further comprising:

receiving suggested location information from said video snipping server for selection by a user.
9. The method of Claim 1, wherein said determining location information comprises:

determining said location information corresponding to a location of a device when capturing said source digital video.
10. The method of Claim 1, wherein said determining location information comprises:

determining geographic coordinate information as said location information corresponding to a location of an object captured within said marked moment.
11. The method of Claim 10, wherein said determining location information comprises:

receiving said geographic coordinate information as defined by a user.
12. The method of Claim 1, wherein said determining location information comprises:

receiving a place name as defined by a user that is associated with an object in said marked moment.
13. A method for distribution, comprising:

receiving a request for a marked video snip from a viewer's computer;

determining a source digital video associated with said marked video snip;

requesting and receiving said source digital video from a host video server;

determining a marked time associated with a marked moment in said source digital video, wherein said marked moment is associated with an object; and

sending said source digital video to said viewer's computer, wherein said source digital video is aligned to play at said marked moment.
14. The method of Claim 13, wherein said object comprises location information.
15. The method of Claim 13, wherein said receiving a request comprises;

receiving said request for a marked video snip file, wherein said marked video snip file comprises a globally unique video identifier for said source digital video associated with a video host server hosting said source digital video, and said marked time.
16. A video snipping system, comprising:

a video controller for determining a globally unique video identifier identifying a source digital video;

a timestamp monitor for determining a marked time in a timeline of said source digital video, wherein said marked time is associated with a marked moment in said source digital video; and

a marking module for associating location information with said marked moment.
17. The video snipping system of Claim 16, further comprising:

a marked video snip file comprising said globally unique video identifier, said marked time, and said location information.
18. The video snipping system of Claim 16, wherein said globally unique video identifier comprises a URI of a video server hosting said source digital video.
19. The video snipping system of Claim 16, wherein said location information comprises:

geographic coordinate information.
20. The video snipping system of Claim 16, wherein said location information comprises GPS coordinate information.
21. The video snipping system of Claim 16, wherein said location information comprises:

a place name.
22. The video snipping system of Claim 16, further comprising:

a marked video snip comprising a subset of said source digital video beginning at a start time comprising said marked time.

A system and method for object association with marked moments in a digital video is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The one or more present inventions, in various embodiments, include components, methods, processes, systems and/or apparatus substantially as depicted and described herein, including various embodiments, subcombinations, and subsets thereof. Those of skill in the art will understand how to make and use the present invention after understanding the present disclosure.

The present invention, in various embodiments, includes providing devices and processes in the absence of items not depicted and/or described herein or in various embodiments hereof, including in the absence of such items as may have been used in previous devices or processes (e.g., for improving performance, achieving ease and/or reducing cost of implementation).

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention (e.g., as may be within the skill and knowledge of those in the art, after understanding the present disclosure). It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed:

1. A method for marking video, comprising:
determining a marked moment of a source digital video by a computer; and
associating a representation of an object with said marked moment.

2. The method of claim 1, wherein said determining a marked moment comprises:
receiving from a user's computer a video identifier for said source digital video; and
determining a marked time for said marked moment in said source digital video.

3. The method of claim 2, further comprising:
recognizing a user's intent to mark said marked moment in said source digital video being played at a computer of said user;
determining a source video URI as said video identifier, wherein said source digital video is hosted by a video server; and
determining at said user's computer a marked time in a timeline for said marked moment.

4. The method of claim 3, further comprising:
pausing play of said source digital video at said marked moment at said user's computer.

5. The method of claim 2, further comprising:
accessing by said computer said source digital video;
sending a marking interface to said user's computer; and
sending said source digital video to said user's computer for playing in conjunction with said marking interface, wherein said source digital video is aligned at said marked moment.

6. The method of claim 5, further comprising:
receiving from said user's computer said representation of said object at said computer.

7. The method of claim 1, further comprising:
marking said source digital video with a video identifier for said source digital video, a marked time in a timeline corresponding to said marked moment, and said representation of an object.

8. The method of claim 1, wherein said associating a representation of an object further comprises:
receiving from said user's computer a caption as said object at said computer.

9. The method of claim 2, further comprising:
creating a marked video identifier based on said video identifier and a user identifier of said user.

10. The method of claim 1, further comprising:
generating a marked video URI providing access to a marked video comprising said source digital video that is marked with one or more marked moments;
determining a list of contacts of interest to said user;
generating a notification of said marked video, wherein said notification comprises said marked video URI;
receiving a message to attach to said notification; and
sending said notification and message to each of said list of contacts.

11. The method of claim 10, further comprising:
receiving a request to access said marked video URI from a viewer's computer;
accessing by said computer said source digital video from said video server;
sending a marking interface to said viewer's computer; and
sending said source digital video to said viewer's computer for playing in conjunction with said marking interface, wherein said video is aligned to begin play at said marked moment in said viewer's computer.

12. The method of claim 1, wherein said object is taken from a group consisting essentially of:
a caption;
an individual;
an entity;
a geo location;
an image; and
another video.

13. A video snipping system, comprising:
a video controller for determining a video identifier identifying a source digital video;
a timestamp monitor for determining a marked time in a timeline of said source digital video, wherein said marked time is associated with a marked moment in said source digital video; and
a marking module for associating a representation of an object with said marked moment.

14. The video distribution system of claim 13, video identifier comprises a source video URI that is received by said video controller from a user's computer marking said source digital video, said source video URI pointing to a video server hosting said source digital video.

15. The video distribution system of claim 13, further comprising:
a marked video URI providing access to a marked digital video comprising said source digital video that is marked with said video identifier, said marked time, and said representation of an object.

16. The video distribution system of claim 15, further comprising:
a snip corresponding to said marked digital video, wherein said snip comprises a subset of said source digital video beginning at a start time comprising said marked time.

17. The video distribution system of claim 15, further comprising:
a notification module for determining a list of contacts of interest to a user marking said source digital video, said notification module generating a notification of said marked digital video, wherein said notification comprises said marked video URI and a message received from a user's computer to attach to said notification, and wherein said notification module sends said notification to each of said list of contacts.

18. The video distribution system of claim 17, wherein said video controller receives said marked video URI from a viewer's computer, accesses said source digital video, and delivers said source digital video to said viewer's computer, and wherein said source digital video is aligned to play said source digital video at said marked time.

19. The video distribution system of claim 13, further comprising:
an interface controller for sending a marking interface and said source digital video to a user's computer marking said source digital video, wherein said interface controls marking of said source digital video.

20. The video distribution system of claim 13, wherein said marking module marks said source digital video with said marked time, said video identifier, and a caption as said object.

21. The video distribution system of claim 13, wherein said object is taken from a group consisting essentially of:
an individual;
an entity;
a geo location;
a place;
an image; and
another video.

22. A marking of digital information, comprising:
a video identifier identifying a source digital video;
a marked time in a timeline of said source digital video, wherein said marked time is associated with a marked moment in said source digital video; and
a representation of an object associating said marked moment and said object.

23. The digital identifier of claim 22, wherein said video identifier comprises a source URI pointing to a video server hosting said source digital video.

24. The digital identifier of claim 22, further comprising:
a user identifier associated with a user creating said marked moment.

25. The digital identifier of claim 22, further comprising:
a snip of said source digital video, wherein said snip comprises a subset of said source digital video beginning at said marked time and ending at an end time.

26. The digital identifier of claim 25, further comprising:
a marked URI providing access to a marked digital video comprising said video identifier, said marked time, and said tag.

27. Digital information, comprising:
a moment in a source digital video; and
a representation of an object associated with said moment.
